(19) United States
(12) Patent Application Publication
(10) Pub. No.: US 2010/0191825 A1
(43) Pub. Date: Jul. 29, 2010

(54) CONTENT ACQUISITION APPARATUS, PROGRAM, CONTENT ACQUISITION METHOD AND CONTENT ACQUISITION SYSTEM

(76) Inventors: Yasuaki Yamagishi, Kanagawa (JP); Yasushi Minoya, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/594,887

(22) PCT Filed: Oct. 14, 2008
(86) PCT No.: PCT/JP2008/068566

§ 371 Date: Oct. 6, 2009

(30) Foreign Application Priority Data
Oct. 15, 2007 (JP) 2007-268411

(51) Int. Cl. G06F 15/16

(52) U.S. Cl. 709/217

(57) ABSTRACT

[Object] To provide a content acquisition apparatus, a program, a content acquisition method and a content acquisition system.

[Solving Means] A content acquisition apparatus includes a receiving section for receiving an RSS feed including first location information indicating a location of metadata of multiple divided data acquired by dividing content data, a metadata acquisition section for acquiring the metadata from the location indicated in the first location information included in the RSS feed, a scheme establishment section for establishing an acquisition scheme for acquiring the multiple divided data based on an attribute of each divided data or an attribute of a divided data group including two or more divided data indicated by the metadata, and a divided data acquisition section for acquiring a part or all of the multiple divided data according to the acquisition scheme established by the scheme establishment section.

### TECHNICAL FIELD

The present invention relates to a content acquisition apparatus, a program, a content acquisition method and a content acquisition system.

### BACKGROUND ART

In recent years, a method of downloading a content file through an RSS (Rich Site Summary) feed has become widespread. Specifically, a URL of a target content file is described in HTTP and the like in an <enclosure> tag included in the RSS feed, and an information processing apparatus such as a PC (Personal Computer) or a mobile phone can download the content file based on the URL. Such downloading of a content file using an RSS feed is described in, for example, Patent Document 1.

[Patent Document 1] JP-A-2007-166363

### DISCLOSURE OF THE INVENTION

### Problems to be Solved by the Invention

Here, since reproduction of content is started after the content file is downloaded, in case of reproducing a very large content file such as an HD (High Definition) video file, depending on the condition of the network, it often takes time until the reproduction is started. Although it is possible to improve efficiency of acquiring a content file by using a P2P file-sharing protocol, for example, even in such a case, the reproduction is not started until the entire content file is collectively acquired.

On the other hand, if a content file is divided into multiple file segments (divided data) and a URL of each file segment is described in the RSS feed, the information processing apparatus can acquire the file segments in parallel from the multiple URLs, and thus, the acquisition may be speeded up.

However, some users may want to acquire not all the file segments of the content file, but only the file segments for partial, specific contents, or they may want to acquire the file segments in a specific order. With the conventional RSS feed, since details per file segment cannot be obtained, it is difficult to respond to such request relating to the acquisition of the file segment.

Thus, the present invention has been achieved in view of the above-described problem, and the object of the present invention is to provide a content acquisition apparatus, a program, a content acquisition method and a content acquisition system that are new and improved, and that are capable of establishing an acquisition scheme for acquiring multiple divided data based on the description of an RSS feed.

### Means for Solving the Problem

To solve the above-described problem, according to an aspect of the present invention, there is provided a content acquisition apparatus including a receiving section for receiving an RSS feed including first location information indicating a location of metadata of multiple divided data acquired by dividing content data, a metadata acquisition section for acquiring the metadata from the location indicated in the first location information included in the RSS feed, a scheme establishment section for establishing an acquisition scheme for acquiring the multiple divided data based on an attribute of each divided data or an attribute of divided data group including two or more divided data indicated by the metadata, and a divided data acquisition section for acquiring a part or all of the multiple divided data according to the acquisition scheme established by the scheme establishment section.

With such a configuration, the metadata of multiple divided data acquired by dividing content data is acquired by the metadata acquisition section. Accordingly, the scheme establishment section can establish an acquisition scheme for acquiring the multiple divided data based on the metadata acquired by the metadata acquisition section. Further, since the divided data acquisition section acquires the divided data according to the acquisition scheme, it becomes possible for the content acquisition apparatus to acquire only a part of the multiple divided data or to acquire the divided data in a specific order, for example.

The metadata may include divided data specifying information indicating each of the multiple divided data, a location information storage apparatus specified based on the divided data specifying information may store second location information indicating a location of the divided data, and the divided data acquisition section may acquire the second location information of the divided data from the location information storage apparatus specified based on the divided data specifying information and acquire the divided data from a content storage apparatus indicated by the second location information.

Here, there is a case where the content storage apparatus storing the divided data is varied by being increased or decreased. Thereby, when the location information of the divided data is described in the divided data specifying information, a case may be assumed where the divided data cannot be acquired from the location indicated by the divided data specifying information or the location indicated by the divided data specifying information is not the optimum source for acquiring the divided data. Thus, by configuring the divided data specifying information as described above such that it is possible to specify the location information storage apparatus storing the location information of the divided data, the acquisition section can acquire the divided data more appropriately.

The RSS feed received by the receiving section may further include category information indicating a category of the RSS feed, and the metadata acquisition section may acquire the metadata from the location indicated by the first location information included in the RSS feed including specific category information. With such a configuration, even when a large number of RSS feeds are received by the receiving section, only the RSS feed including specific category information may be extracted and be used.

The metadata may include information indicating a priority rank of the divided data. With such a configuration, the scheme establishment section can establish an acquisition scheme based on the priority rank of each divided data. For example, the scheme establishment section may establish an acquisition scheme where the divided data is acquired sequentially from the divided data with the highest priority or only the divided data with high priority is acquired.

The metadata may include a summary of the divided data. With such a configuration, the scheme establishment section can establish an acquisition scheme based on the summary of each divided data. For example, the scheme establishment section may establish an acquisition scheme where only the divided data including a specific summary is acquired.

Further, to solve the above-described problem, according to another aspect of the present invention, there is provided a program for causing a computer to function as a receiving section for receiving an RSS feed including first location information indicating a location of metadata of multiple divided data acquired by dividing content data, a metadata acquisition section for acquiring the metadata from the location indicated in the first location information included in the RSS feed, a scheme establishment section for establishing an acquisition scheme for acquiring the multiple divided data based on an attribute of each divided data or an attribute of divided data group including two or more divided data indicated by the metadata, and a divided data acquisition section for acquiring a part or all of the multiple divided data according to the acquisition scheme established by the scheme establishment section.

With such a program, it becomes possible to have hardware resources of computer including a CPU, a ROM or a RAM, for example, execute functions of the receiving section, the metadata acquisition section, the scheme establishment section and the divided data acquisition section as described above. That is, it becomes possible to have a computer using the program function as the above-described content acquisition apparatus.

Further, to solve the above-described problem, according to another aspect of the present invention, there is provided a content acquisition method to be executed in a content acquisition apparatus, including the steps of receiving an RSS feed including first location information indicating a location of metadata of multiple divided data acquired by dividing content data, acquiring the metadata from the location indicated in the first location information included in the RSS feed, establishing an acquisition scheme for acquiring the multiple divided data based on an attribute of each divided data or an attribute of divided data group including two or more divided data indicated by the metadata and acquiring a part or all of the multiple divided data according to the established acquisition scheme.

Further, to solve the above-described problem, according to another aspect of the present invention, there is provided a content acquisition system including an RSS generation apparatus for generating an RSS feed and a content acquisition apparatus for acquiring the RSS feed generated by the RSS generation apparatus. The RSS generation apparatus generates the RSS feed including first location information indicating a location of metadata of multiple divided data acquired by dividing content data. Further, the content acquisition apparatus includes a receiving section for receiving the RSS feed generated by the RSS generation apparatus, a metadata acquisition section for acquiring the metadata from the location indicated in the first location information included in the RSS feed, a scheme establishment section for establishing an acquisition scheme for acquiring the multiple divided data based on an attribute of each divided data or an attribute of divided data group including two or more divided data indicated by the metadata, and a divided data acquisition section acquiring a part or all of the multiple divided data according to the acquisition scheme established by the scheme establishment section.

### EFFECT OF THE INVENTION

As explained above, according to the content acquisition apparatus, the program, the content acquisition method and the content acquisition system, an acquisition scheme for acquiring multiple divided data based on the description of an RSS feed can be established.

### BRIEF DESCRIPTION OF THE DRAWINGS

FIG. 1 It is an explanatory diagram showing a configuration of a content acquisition system according to a present embodiment.

FIG. 2 It is an explanatory diagram showing a flow of acquiring content in a content acquisition system relating to the present embodiment.

FIG. 3 It is an explanatory diagram showing a flow of acquiring content in the content acquisition system relating to the present embodiment.

FIG. 4 It is an explanatory diagram showing a flow of acquiring content in the content acquisition system relating to the present embodiment.

FIG. 5 It is an explanatory diagram showing a flow of acquiring content in the content acquisition system according to the present embodiment.

FIG. 6 It is an explanatory diagram showing a flow of acquiring content in the content acquisition system according to the present embodiment.

FIG. 7 It is an explanatory diagram showing a hardware configuration of a node according to the present embodiment.

FIG. 8 It is a function block diagram showing a configuration of the node according to the present embodiment.

FIG. 9 It is an explanatory diagram showing an example of a hash-value management range assigned to each node.

FIG. 10 It is an explanatory diagram showing an example of a name resolution table stored in a name resolution table storage section.

FIG. 11 It is an explanatory diagram showing a concrete example of an RSS feed to be acquired by an RSS acquisition section.

FIG. 12 It is an explanatory diagram showing an example of a schema of a file segment metafile.

FIG. 13 It is an explanatory diagram schematically showing the contents of the schema of the file segment metafile.

FIG. 14 It is an explanatory diagram showing a description example of the file segment metafile.

FIG. 15 It is an explanatory diagram schematically showing the contents of the file segment metafile.

FIG. 16 It is a sequence diagram showing a flow from chunking of content to releasing of an RSS feed.

FIG. 17 It is a sequence diagram showing a flow of an RSS multicast server multicasting an RSS feed.

FIG. 18 It is a sequence diagram showing a flow of acquiring the file segment metafile.

FIG. 19 It is a sequence diagram showing a flow from acquisition of a file segment to reproduction of content.

FIG. 20 It is a sequence diagram showing a flow from acquisition of a file segment to reproduction of content.

FIG. 21 It is a sequence diagram showing a flow from acquisition of a file segment to reproduction of content.

FIG. 22 It is a sequence diagram showing a flow from acquisition of a file segment to reproduction of content.

### BEST MODE FOR CARRYING OUT THE INVENTION

Hereinafter, preferred embodiments of the present invention will be explained in detail with reference to the appended drawings. Note that, in this specification and the appended drawings, structural elements that have substantially the same function and structure are denoted with the same reference numerals, and repeated explanation of these structural elements is omitted.

Further, the best mode for carrying out the invention will be explained in the order shown below.

(1) Overview of a content acquisition system according to a present embodiment

(2) Purpose of the present embodiment

(2-1) A content acquisition system relating to the present embodiment

(2-2) Purpose of the present embodiment

(3) Detailed description of the content acquisition system

(3-1) Hardware configuration of a node

(3-2) Functions of the node

(3-3) Operation of the content acquisition system

(4) Conclusion

### (1) Overview of a Content Acquisition System According to a Present Embodiment

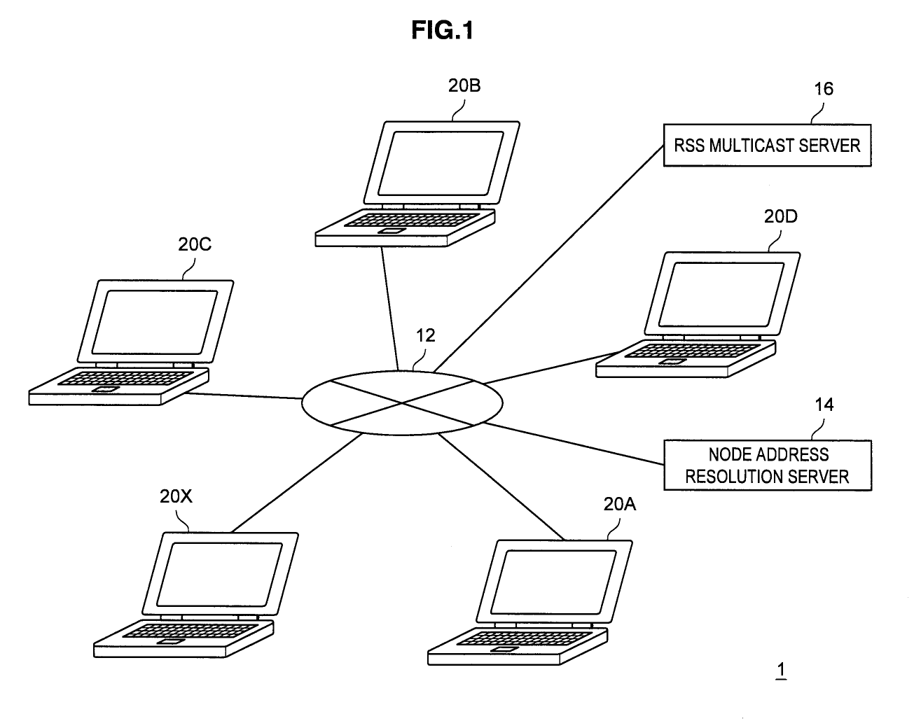

First, with reference to FIG. 1, an overview of a content acquisition system 1 according to the present embodiment will be explained.

FIG. 1 is an explanatory diagram showing a configuration of the content acquisition system 1 according to the present embodiment. As shown in FIG. 1, the content acquisition system 1 includes multiple nodes such as nodes 20A, 20B, 20C, 20D and 20X, a node address resolution server 14, and an RSS multicast server 16. Incidentally, in this specification, when there is no need to distinguish between each of the nodes such as the nodes 20A, 20B, 20C, 20D and 20X, they are simply referred to as the node 20. The same is said of other numerals.

Each node 20 stores content data (file) which is real data of content or a file segment (divided data) acquired by chunking (dividing) the content data. Further, each node 20 stores a URL (Uniform Resource Locator) as location information indicating a location where a predetermined file segment is stored. That is, each node 20 has a function of a content storage apparatus and a function of a location information storage apparatus.

Further, each node 20 also has a function of a content acquisition apparatus for receiving an RSS feed including in an <enclosure> element information indicating certain content and for acquiring via a communication network 12 file segments stored in other nodes 20. For example, each node 20 can receive the RSS feed multicast by the RSS multicast server 16.

Briefly explaining, each node 20 specifies based on information described in the <enclosure> element of the RSS feed, in cooperation with the node address resolution server 14, one or two or more nodes 20 storing a URL of each file segment of certain content. Here, the node address resolution server 14 stores, in association with each other, a node ID as unique identification information for identifying each node 20 and a network address assigned to each node 20 on the network. When requested to resolve the network address of a node 20 having a certain node ID, the node address resolution server 14 transmits the network address stored in association with the node ID.

When each node 20 specifies one or two or more nodes 20 storing the URL of each file segment of certain content, each node 20 acquires the URL of each file segment from each of the specified nodes 20. Thus, each node 20 can acquire the file segment based on the URL of each file segment.

Incidentally, in FIG. 1, although a laptop computer is shown as an example of the node 20, the node 20 is not limited to a laptop computer. For example, it may be an information processing apparatus such as a personal computer, an image processing apparatus in homes (a DVD recorder, a video cassette recorder and the like), a mobile phone, a PHS (Personal Handyphone System), a portable music playback device, a portable image processing device, a PDA (Personal Digital Assistants), a home game machine, a portable game machine, home electronics and the like.

Further, the content is a concept that includes music data such as music, lectures, radio programs and the like, image data such as movies, television programs, video programs, photographs, documents, paintings, diagrams and the like, and any other type of data such as games, software and the like.

### (2) Purpose of the Present Embodiment

Subsequently, to make it easy to comprehend the present embodiment, the purpose of the content acquisition system 1 according to the present embodiment will be explained in comparison with a content acquisition system 2 relating to the present embodiment.

### (2-1) A Content Acquisition System Relating to the Present Embodiment

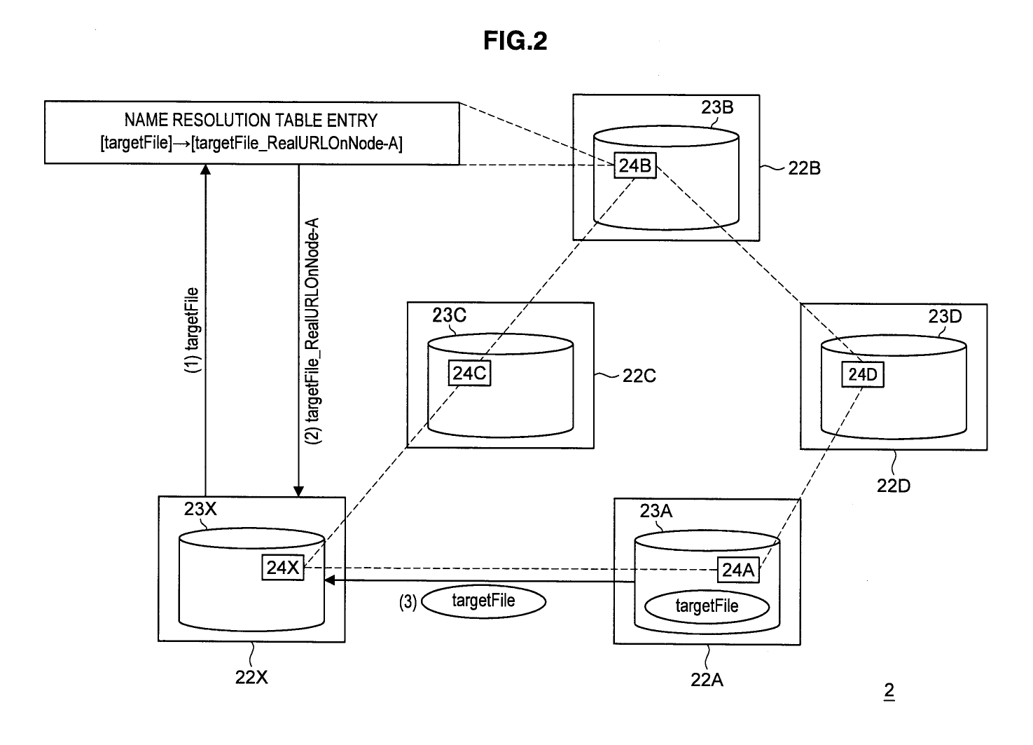

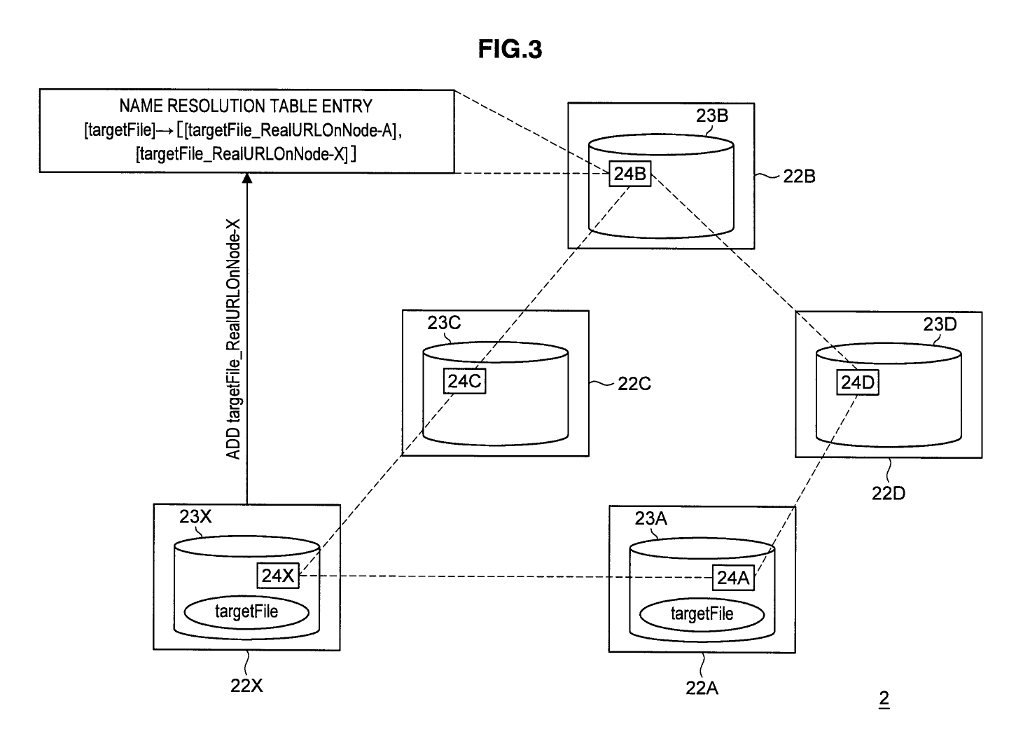

FIGS. 2 to 4 are explanatory diagrams showing flows of acquiring content in the content acquisition system 2 relating to the present embodiment.

When a certain node 22A holds a “targetFile (target file name)” which is a file to be acquired, the node 22A generates an RSS feed for notifying other nodes 22 that the targetFile exists in the storage section 23A of the node 22A. Normally, a URL “targetFile_RealURLOnNode-A” for acquiring the entity of the file is described in the url attribute of the <enclosure> element of the RSS feed.

Then, another node 22 acquires the RSS feed thus generated, and acquires the target file “targetFile” by using a file acquisition protocol based on “targetFile_RealURLOnNode-A” described in the RSS feed.

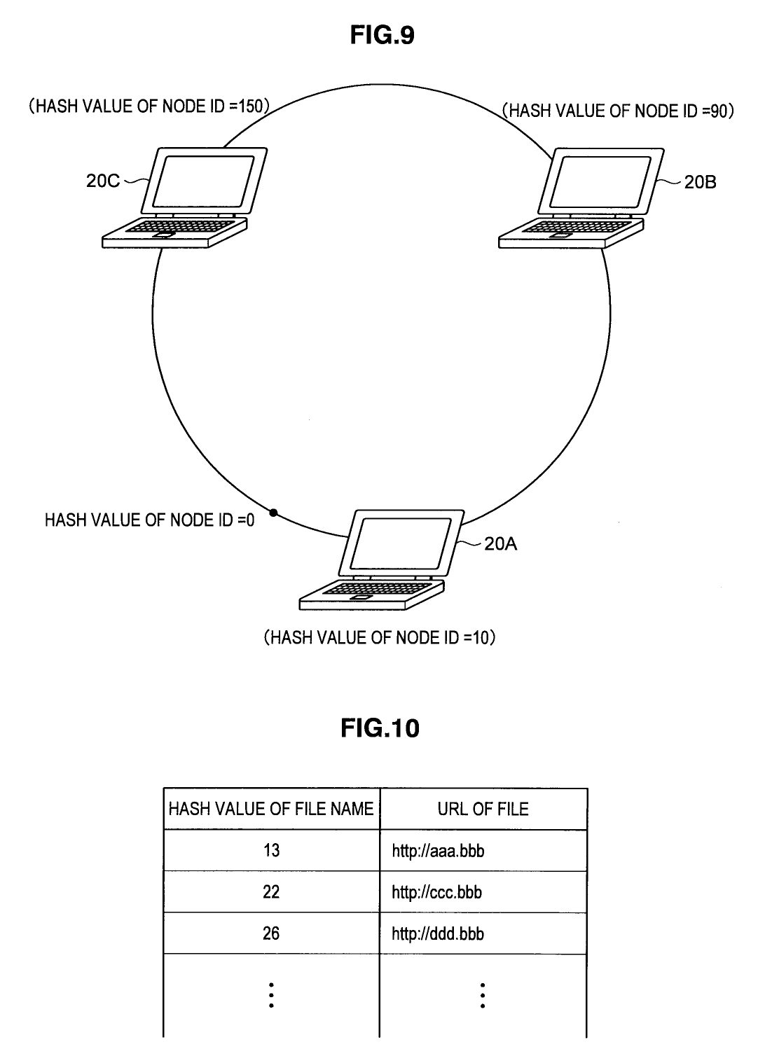

Here, a DHT (Distributed Hash Table) is configured based on the item <file name> in the url attribute of the <enclosure> element, and an entry in the name resolution table of <URL of file main body> is referred to based on the <file name> by using the DHT. Details of the DHT will be explained with reference to FIG. 9.

In this case, the node 22 intending to download the targetFile resolves the URL of the file by using the DHT distributed to corresponding nodes according to hash values of the file names, and acquires the main body of the file. That is, the node 22 acquires the URL of the file by referring to the name resolution table, in which correspondence relationship between a hash value of the <target file name> and the <URL of file main body> is described.

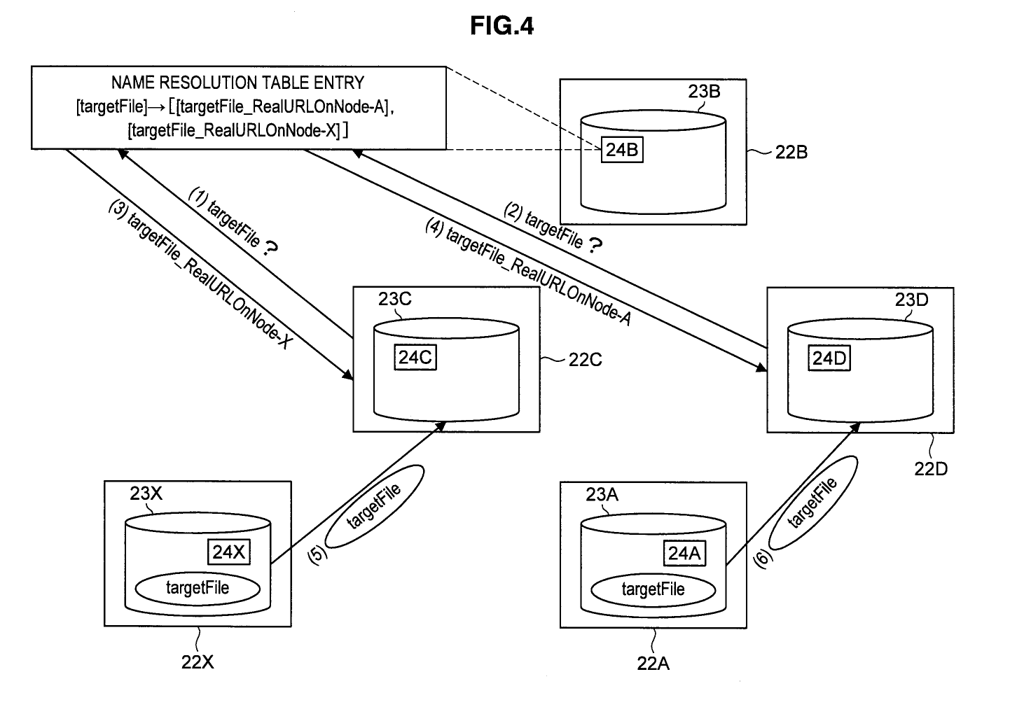

For example, a case is considered where, as shown in FIG. 2, name resolution tables 24A, 24B, 24C, 24D and 24X are distributed to the nodes 22A, 22B, 22C, 22D and 22X as indicated by the dotted lines and are stored therein. In this case, the name resolution table 24B, which is for searching for the URL of the file main body (targetFile_RealURLOnNode-A) based on the target file name, is managed by a node determined by a hash value (hash(targetFile)) of the name of the target file “targetFile” (in this case, the node 22B). Incidentally, in FIGS. 4 to 6, dotted lines connecting each name resolution table are omitted for the sake of clarity of the drawings.

The node 22X intending to acquire the targetFile acquires an RSS feed describing metadata regarding the targetFile (“targetFile” is described in the url attribute of the <enclosure> element). Then, the node 22X refers to the name resolution table 24B in the node 22B by using the DHT, acquires “targetFile_RealURLOnNode-A”, which is the URL of the targetFile, and acquires the contents of the targetFile. Further, the node 22X stores the acquired targetFile in a storage section 23X.

Then, immediately after storing the file in the storage section 23X, the node 22X adds a URL “targetFile_RealURLOnNode-X” of the targetFile in the storage section 23X after the item “targetFile_RealURLOnNode-A” of a pair consisting of “targetFile”->“targetFile_RealURLOnNode-A”, which is the name resolution table entry managed in the node 22B.

As a result, the URL that is sent back in response to the name resolution request to the node 22B regarding the targetFile will be the two URLs, “targetFile_RealURLOnNode-A” and “targetFile_RealURLOnNode-X”.

Thus, as shown in FIG. 4, it becomes possible for the multiple nodes 22 to acquire the same file from different nodes. For example, when the node 22C and the node 22D desire to acquire a targetFile, the node 22C and the node 22D refer to the name resolution table 24B of the node 22B.

Then, it is assumed that the node 22C acquires “targetFile_RealURLOnNode-X” and the node 22D acquires “targetFile_RealURLOnNode-A”. In this case, it is made possible for the nodes to acquire the targetFile simultaneously in parallel, such as the node 22C from the node 22X and the node 22D from the node 22A, for example.

Similarly, whenever another node 22 acquires a file, the URL of the file on the node 22 which acquired the file is added to the entry of the name resolution table. With such a configuration, as the copies of the file are distributed to the nodes 22, it becomes possible for the multiple nodes 22 to acquire a copy of the same file from different nodes 22 at the same time.

On the other hand, as shown in FIG. 4, when requests for resolution of a name of a certain file concentrate on the node 22B, the load on the node 22B increases and the processing performance for each request for name resolution deteriorates, and further, the overall processing speed is slowed.

### (2-2) Purpose of the Present Embodiment

Thus, with the alleviation of the problem as one purpose, it has been led to a concept of chunking a file into multiple file segments to store the file segments in the multiple nodes 20. For example, a file name <file name+n> (n is a file segment ID: 1, 2, . . . , N) is assigned to each file segment, and a certain node 20 manages a set of <file name+n>-> <(copies of file segment) URL, URL, . . . > as a name resolution table entry. Thus, one file name may be divided into multiple keys such as “file name-1”, “file name-2”, “file name-3”, . . . , and be distributed in a hash space, and a DHT search processing using a file name as a key may be performed in a distributed manner.

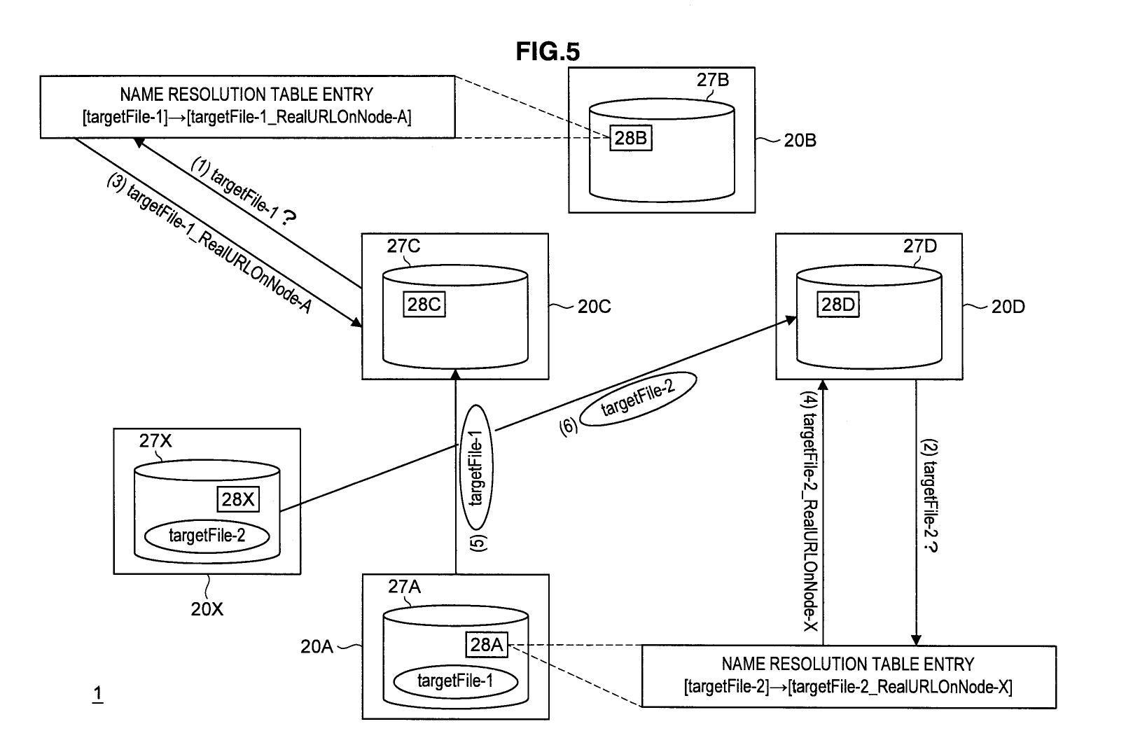

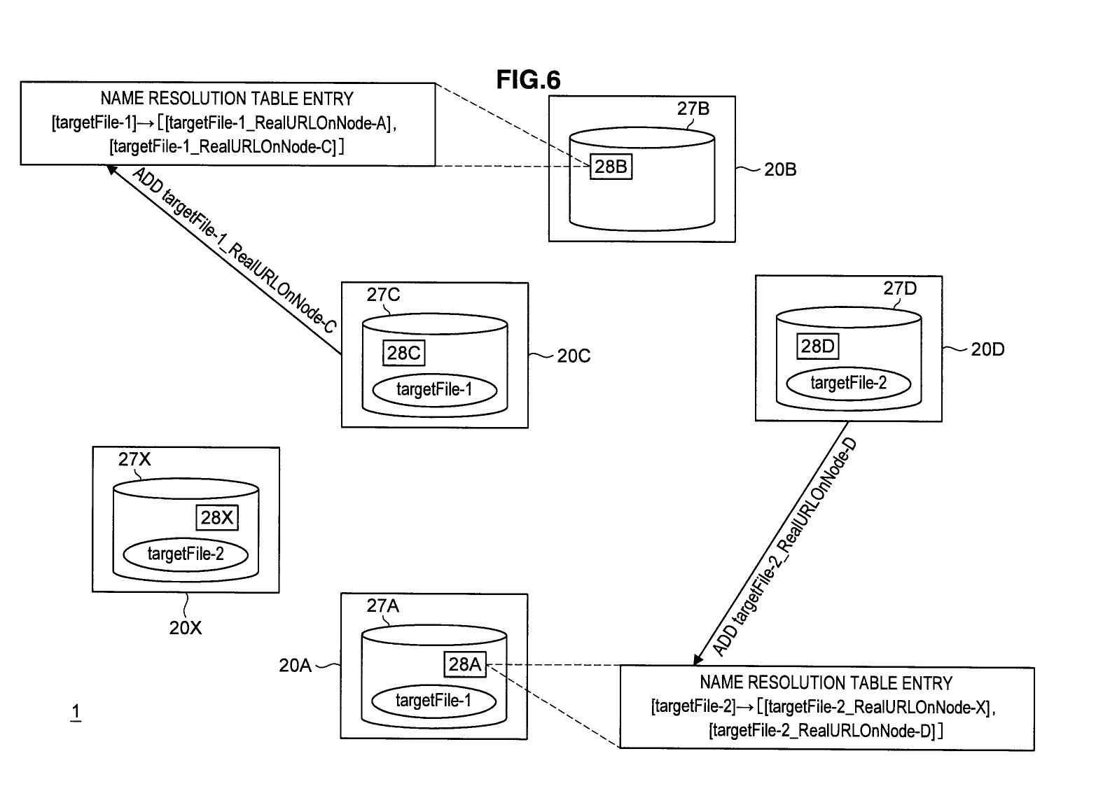

FIGS. 5 and 6 are explanatory diagrams showing flows of acquiring content in the content acquisition system 1 according to the present embodiment. As shown in FIG. 5, “targetFile” is chunked into “targetFile-1” and “targetFile-2”, and the entity of the file “targetFile-1” is stored in a storage section 27A of the node 20A and the entity of the file “targetFile-2” is stored in a storage section 27X of the node 20X.

Further, the entry in a name resolution table regarding “targetFile-1” is managed by the node 20B and the entry in a name resolution table regarding “targetFile-2” is managed by the node 20A. “targetFile-1_RealURLOnNode-A”, which is the URL of the entity of “targetFile-1”, is stored in the entry of “targetFile-1”. Further, “targetFile-2_RealURLOnNode-X”, which is the URL of the entity of “targetFile-2”, is stored in the entry of “targetFile-2”.

Here, the node 20C intending to acquire “targetFile-1” performs a name resolution request to the node 20B since the name resolution table entry for resolving the URL of the entity of “targetFile-1” exists in the node 20B. Similarly, the node 20D intending to acquire “targetFile-2” performs a name resolution request to the node 20A since the name resolution table entry for resolving the URL of the entity of “targetFile-2” exists in the node 20A.

As a result, the node 20C acquires “targetFile-1_RealURLOnNode-A”, which is the URL of “targetFile-1”, and acquires “targetFile-1” from the node 20A. Similarly, the node 20D acquires “targetFile-2_RealURLOnNode-X”, which is the URL of “targetFile-2”, and acquires “targetFile-2” from the node 20X.

Further, as shown in FIG. 6, the node 20C, which acquired “targetFile-1”, transmits to the node 20B “targetFile-1_RealURLOnNode-C” indicating the URL of “targetFile-1” in a storage section 27C. Then, the node 20B adds “targetFile-1_RealURLOnNode-C” as the URL of “targetFile-1”.

Similarly, the node 20D, which acquired “targetFile-2”, transmits to the node 20A “targetFile-2_RealURLOnNode-D” indicating the URL of “targetFile-2” in a storage section 27D. Then, the node 20A adds “targetFile-2_RealURLOnNode-D” as the URL of “targetFile-2”.

Here, to realize a system of storing file segments of a content in multiple nodes 20 in a distributed manner as described above, a method can be conceived of describing each file segment name in an <enclosure> element in an RSS feed.

However, if the number of the file segments becomes large, the description of the <enclosure> element in the RSS feed becomes redundant resulting in an increase in the processing load of an RSS directory server, the RSS multicast server 16 or the like providing the RSS feed. Further, there is also a problem that the resources of the nodes 20 receiving the RSS feed will be strained.

Further, some users may want to acquire not all the file segments of a certain content file, but only the file segments for partial, specific contents, or they may want to acquire each file segment in a specific order. However, since details per file segment cannot be obtained from a normal RSS feed, there is a problem that such request relating to the acquisition of the file segment cannot be fulfilled.

Thus, in view of the above-described circumstance, the content acquisition system 1 according to the present embodiment has been achieved. According to the content acquisition system 1 according to the present embodiment, an acquisition scheme for acquiring multiple file segments can be established based on the description of an RSS feed. Hereunder, the content acquisition system 1 will be explained in detail.

### (3) Detailed Description of the Content Acquisition System

Hereunder, the content acquisition system 1 will be explained in detail in the order of hardware configuration of the node 20, functions of the node 20 and the operation of the content acquisition system.

### (3-1) Hardware Configuration of a Node

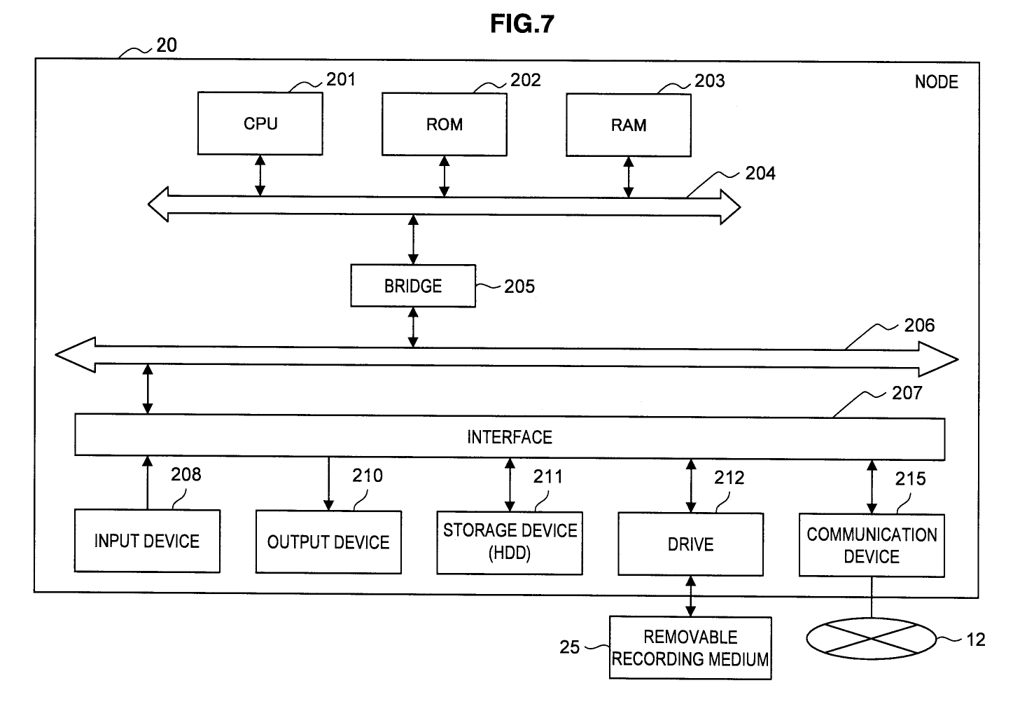

FIG. 7 is an explanatory diagram showing the hardware configuration of the node 20 according to the present embodiment. As shown in FIG. 7, the node 20 includes a CPU (Central Processing Unit) 201, a ROM (Read Only Memory) 202, a RAM (Random Access Memory) 203, a host bus 204, a bridge 205, an external bus 206, an interface 207, an input device 208, an output device 210, a storage device (HDD) 211, a drive 212 and a communication device 215.

The CPU 201 functions as an arithmetic processing unit and a control device, and controls overall operation within the node 20 according to various programs. The CPU 201 may also be a microprocessor. The ROM 202 stores programs to be used by the CPU 201, processing parameters and the like. The RAM 203 temporarily stores the programs to be used by the CPU 201 in its operations, parameters that vary as necessary in the course of the operations, or the like. The CPU 201, the ROM 202 and the RAM 203 are interconnected by the host bus 204, which is configured from a CPU bus and the like.

The host bus 204 is connected to the external bus 206 such as a PCI (Peripheral Component Interconnect/Interface) bus via the bridge 205. Note that the host bus 204, the bridge 205 and the external bus 206 are not necessarily configured separately from each other, and these functions may be implemented in a single bus.

The input device 208 is configured, for example, from an input means to be used by a user to input information, such as a mouse, a keyboard, a touch panel, a button, a microphone, a switch, a lever and the like, and an input control circuit that generates an input signal based on the input by the user and outputs the input signal to the CPU 201. By operating on the input device 208, the user of the node 20 can input various data to the node 20 and issue commands for processing operations.

The output device 210 is configured, for example, from a display device such as a CRT (Cathode Ray Tube) display device, a LCD (Liquid Crystal Display) device, an OLED (Organic Light Emitting Display) device, a lamp or the like, and an audio output device such as a speaker, a headphone or the like. The output device 210 outputs reproduced content, for example. Specifically, the display device displays various information such as reproduced video data in the form of text or images. On the other hand, the audio output device converts reproduced audio data and the like to sound and outputs the sound.

The storage device 211 is a device for storing data configured as an example of a storage section of the node 20 according to the present embodiment. The storage device 211 may include a storage medium, a recording device that records data in the storage medium, a read device that reads data from the storage medium and a deletion device that deletes data recorded in the storage medium. The storage device 211 is configured from a hard disk drive (HDD), for example. The storage device 211 drives a hard disk and stores programs to be executed by the CPU 201 and various data. The storage device 211 also stores the name resolution table, the file segment and the like described later.

The drive 212 is a reader/writer for a storage medium, and is built into or attached externally to the node 20. The drive 212 reads information recorded in a removable recording medium 25 attached, such as a magnetic disk, an optical disk, a magneto-optical disk, a semiconductor memory or the like, and outputs the information to the RAM 203.

The communication device 215 is a communication interface configured from a communication unit for connecting to a communication network 12, for example. Further, the communication device 215 may be a wireless LAN (Local Area Network) compatible communication device, a wireless USB compatible communication device or a wired communication device that communicates by wire. The communication device 215 transmits and receives between the node address resolution server 14 and the other nodes 20 various data such as an RSS feed, a URL and a file segment via the communication network 12.

### (3-2) Functions of the Node

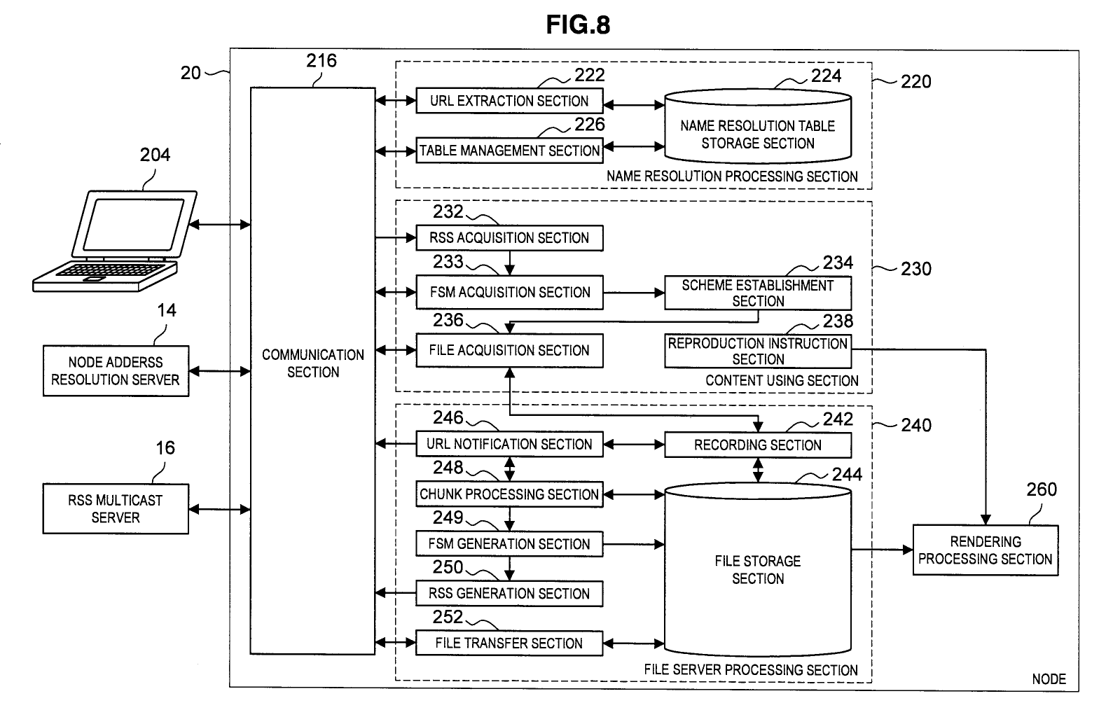

Subsequently, with reference to FIGS. 8 to 15, functions of the node 20 according to the present embodiment will be explained.

FIG. 8 is a function block diagram showing a configuration of the node 20 according to the present embodiment. As shown in FIG. 8, the node 20 includes a communication section 216, a name resolution processing section 220, a content using section 230, a file server processing section 240 and a rendering processing section 260.

The communication section 216 is an interface to the other node 20X, the node address resolution server 14 or the like, and transmits and receives various data. For example, the communication section 216 has a function of a receiving section for receiving an RSS feed from the RSS multicast server 16 or a function of a transmission section for transmitting a URL of a file segment stored in the node that includes the communication section 216. Note that, in this specification, when the node 20 corresponds to the node 20A, for example, nodes other than the node 20A, such as the node 20B and the node 20C may be collectively referred to as the node 20X.

The name resolution processing section 220 includes a URL extraction section 222, a name resolution table storage section 224 and a table management section 226.

The table management section 226 manages the name resolution table stored in the name resolution table storage section 224. The name resolution table is a table containing an entry (name resolution table entry) in which a hash value of a file name of a file (file segments included) and a URL of the file are correlated with each other.

Specifically, a hash-value management range is assigned to each node 20, and each node 20 receives a name resolution table entry in which a hash value of a file name of a file whose hash value of the file name is included in the management range assigned to itself and a URL of the file are correlated with each other. Then, the table management section 226 stores the name resolution table entry received from the other node 20 in the name resolution table storage section 224. Here, with reference to FIG. 9, the hash-value management range assigned to each node 20 will be explained.

FIG. 9 is an explanatory diagram showing an example of the hash-value management range assigned to each node 20. In FIG. 9, a case is shown where the node 20A has a node ID whose hash value is 10, the node 20B has a node ID whose hash value is 90, and the node 20C has a node ID whose hash value is 150. Further, the node 20A and the node 20C are participating in a P2P (Peer to Peer) network whereas the node 20B has not joined. Further, the node 20A and the node 20C are arranged on a ring (virtual ring constituted by arranging hash values of the node IDs in sequence).

In this case, since the hash value of the node ID of the node 20A is 10 and the hash value of the node ID of the node 20C is 150, hash values of 151 to 10 are assigned to the node 20A as the hash-value management range and hash values of 11 to 150 are assigned to the node 20C as the hash-value management range.

Here, when the node 20B tries to join the network, the node 20B searches for the node 20A and the node 20C having the hash values adjacent to the hash value 90 of the node 20B. When there are a larger number of the nodes 20 participating in the network, the node 20B can search for the adjacent nodes using an arbitrary algorithm. For example, the node 20B may first communicate with an arbitrary node, and if the node is not one of the adjacent nodes, the node 20B may obtain information from the node on the nodes adjacent to the node 20B.

When the node 20B obtains the information on the node 20A and the node 20C having the adjacent hash values, since the hash value of the node ID of the node 20A is 10 and the hash value of the node ID of the node 20C is 150, the node 20B sets the hash-value management range of itself to 11 to 90. With the node 20B joining the network, the hash-value management range of the node 20C becomes 91 to 150.

Here, as described above, each node 20 participating in the network stores in correlation with each other a hash value of a file name of a file whose hash value of the file name is included in the management range of itself and a URL of the file. For example, before the node 20B joined the network, the node 20C stored the URL of a file having a file name whose hash value is within the range of 11 to 150. Accordingly, the table management section 226 of the node 20B receives from the node 20C a name resolution table entry which is a pair consisting of a URL of a file having a file name whose hash value is within the range of 11 to 90 and the hash value of the file name of the file from among the name resolution table entry stored in the node 20C, and stores the same.

On the other hand, when leaving the network, the node 20B searches for the node 20C with adjacent hash value, and transmits to the node 20C the name resolution table entry that is stored in the name resolution table storage section 224 of the node 20B. Then, the table management section 226 of the node 20C adds the name resolution table entry received from the node 20B in the name resolution table managed by the node 20C.

Note that the node ID may be random identification information that each node determines based on time, for example, when joining the network, and that is to be held thereby.

Heretofore, the hash-value management range assigned to each node 20 and the processing method at the time of a node joining the network or leaving the network have been explained. However, the above explanation is only an example, and other arbitrary processing methods can be used instead.

When there is a name resolution request from the other node 20X, the URL extraction section 222 sends back an appropriate URL in response to the name resolution request. Here, the URL extraction section 222 may receive as the name resolution request a hash value of a file segment name, for example, and may send back the URL stored in the name resolution table storage section 224 in correlation with the hash value. A node including such name resolution processing section 220 has a function of a location information storage section. Further, an example of the name resolution table stored in the name resolution table storage section 224 is shown in FIG. 10.

FIG. 10 is an explanatory diagram showing an example of the name resolution table stored in the name resolution table storage section 224. As shown in FIG. 10, there are included in the name resolution table multiple name resolution table entries in which hash values of file names and URLs indicating the locations of the files are correlated with each other.

The content using section 230 includes an RSS acquisition section 232, a file segment metafile acquisition section 233 (indicated as a FSM acquisition section in FIG. 8), a scheme establishment section 234, a file acquisition section 236 and a reproduction instruction section 238, and corresponds to an RSS feed reader or an application that is called up by the RSS feed reader.

The RSS acquisition section 232 functions as a receiving section for receiving an RSS feed from the RSS multicast server 16 multicasting the RSS feed, for example. The RSS feed received by the RSS acquisition section 232 is accumulated in an RSS feed local cache, which can be included in the RSS acquisition section 232. Incidentally, it is possible to have only the RSS feed including a <category> element as category information in which specific contents are described accumulated in the RSS feed local cache. Further, the RSS acquisition section 232 may selectively acquire an RSS feed among the RSS feeds stored in the RSS directory server (not shown).

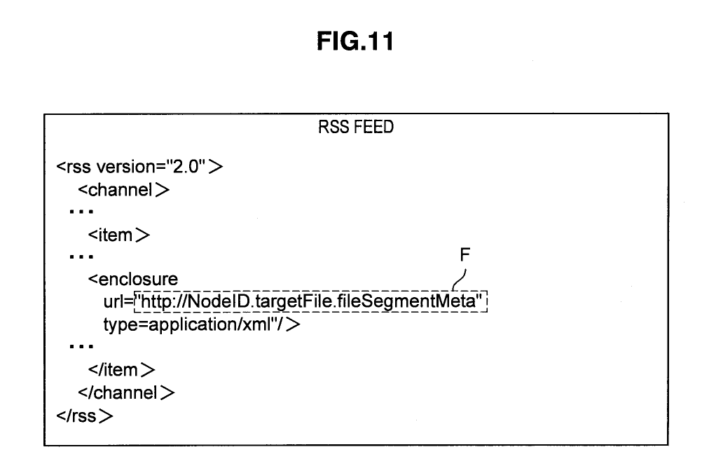

Here, with reference to FIG. 11, a concrete example of an RSS feed to be acquired by the RSS acquisition section 232 will be explained.

FIG. 11 is an explanatory diagram showing the concrete example of an RSS feed to be acquired by the RSS acquisition section 232. As shown in FIG. 11, the RSS feed mainly includes a <channel> element and an <item> element. The <item> element includes an <enclosure> element in which a URL (indicated with an F in FIG. 11) of a file segment metafile to be described later is described. Incidentally, the <channel> element may include the <category> element described above.

The file segment metafile acquisition section 233 acquires a file segment metafile based on the description of the <enclosure> element of the RSS feed, which was acquired by the RSS acquisition section 232 and is accumulated in the RSS feed local cache. That is, the file segment metafile acquisition section 233 has a function of a metadata acquisition section.

The file segment metafile (metadata of divided data) includes attribute information of each of the multiple file segments acquired by chunking certain content or of a file segment group including or two or more file segments.

Specifically, the following and the like may be described in the file segment metafile.

(1) For each file segment:
file segment ID (for example, “NodeID.targetFile.segmentedFileID”)
file segment attribute (more than one) (priority ranking for acquisition in the segment level, etc.)
file segment additional information (more than one) (token for acquisition/reproduction history recording, etc.)

(2) For each file segment group:
file segment group ID (for example, “NodeID.targetFile.segmentedGroupID”) (within the scope of node ID and unique)
file segment group attribute (more than one) (priority ranking for acquisition in the segment group level, etc.)
file segment group additional information (more than one) (token for acquisition/reproduction history recording, etc.)
list of file segment IDs of file segments belonging to the file segment group

Multiple file segments are classified into file segment groups, and the file segment group attribute is applied to the entire grouped file segments.

Further, as the file segment (file segment group) attribute, a category can be defined so that it is possible to determine whether it is important or not (criterion is determined by the owner of the content) and whether it meets the preferences or the needs of the content acquiring side or not. Such category is expressed using an urn as indicated in the following.

When the priority class indicating the priority ranking for acquisition is the highest where the maximum level is three, for example, the priority ranking for acquisition can be expressed as “urn:capturingPriority[higherTheBetter, max3]:3”.

When a content category, which is for the convenience of controlling of priority of acquisition in accordance with the preferences, that depends on the contents of the file segment is a hierarchy of, for example, sport as a genre/baseball/major league, the category can be expressed as

“urn:genre:sport:baseball:majorLeague”.

Further, the file segment group attribute of multiple file segments that include highlights and that are grouped can be expressed as “urn:highlights”.

Further, an element storing the file segment (file segment group) additional information is included in the file segment metafile. For example, the file segment metafile may include a token, which is a character string unique for each file segment (file segment group), for a provider to collect the viewing and listening record for each unit of file segment (file segment group). Such token is signed with a secret key and the like of the provider to prevent alteration, is encoded with base64 and the like, and then, is described in the file segment metafile.

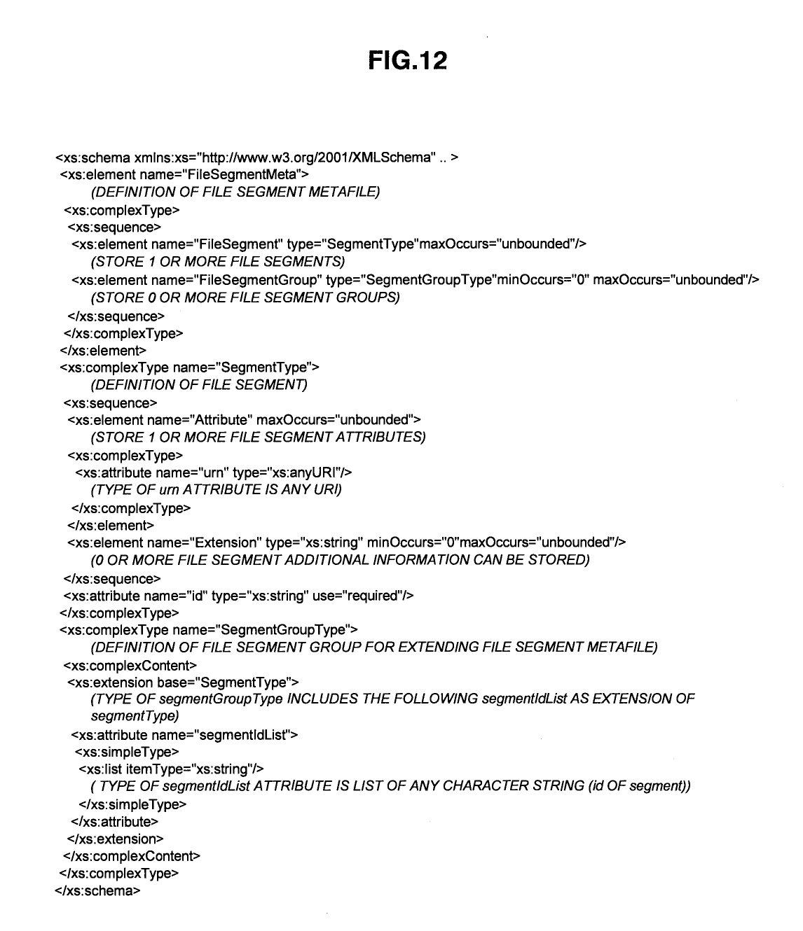

Schema examples and concrete examples of such file segment metafile are shown in FIGS. 12 to 15.

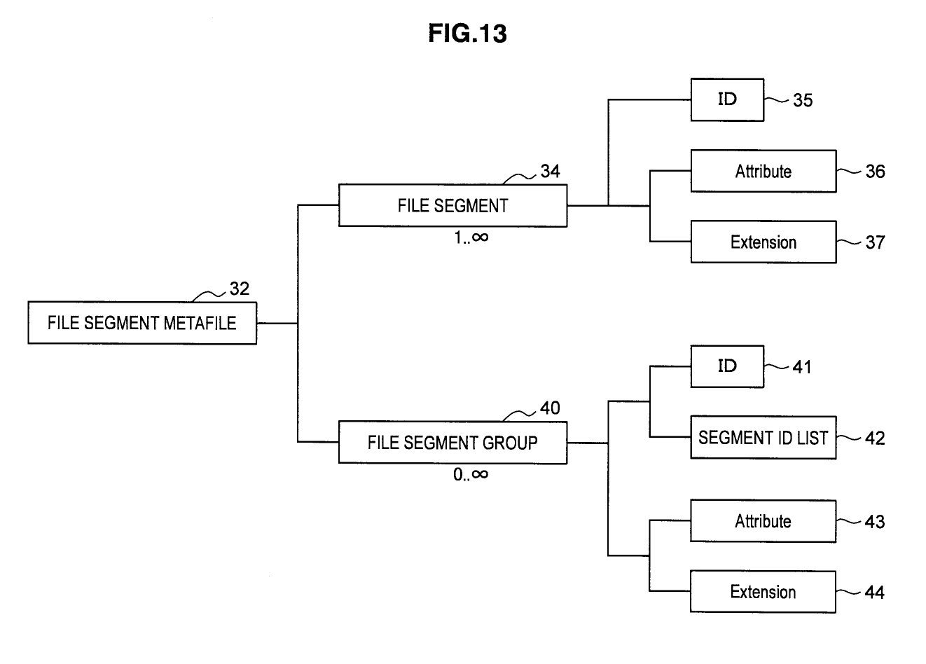

FIG. 12 is an explanatory diagram showing an example of the schema of the file segment metafile. FIG. 13 is an explanatory diagram schematically showing the contents of the schema of the file segment metafile. The character strings in italics shown in FIG. 12 indicate the meaning of the description immediately above each character string. For example, the description in line 6, <xs:element name=“FileSegment” type=“SegmentType” maxOccurs=“unbounded”/>, means that one or more file segments are stored.

According to the schema of the file segment metafile shown in FIG. 12, a file segment 34 and a file segment group 40 are defined in a file segment metafile 32 as shown in FIG. 13. More specifically, it is defined that the number of the file segment 34 is one or more with no upper limit and the number of the file segment group 40 is zero or more with no upper limit.

Further, an ID 35, an Attribute 36 and an Extension 37 are defined in the lower level of the file segment 34. Similarly, an ID 41, a segment ID list 42, an Attribute 43 and an Extension 44 are defined in the lower level of the file segment group 40.

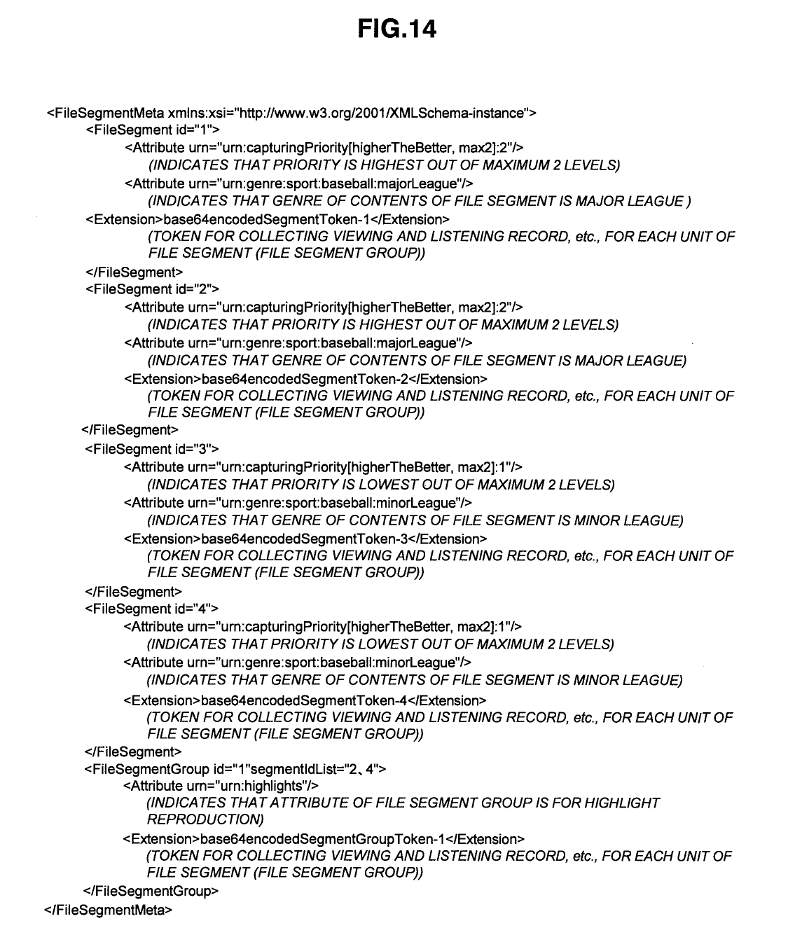

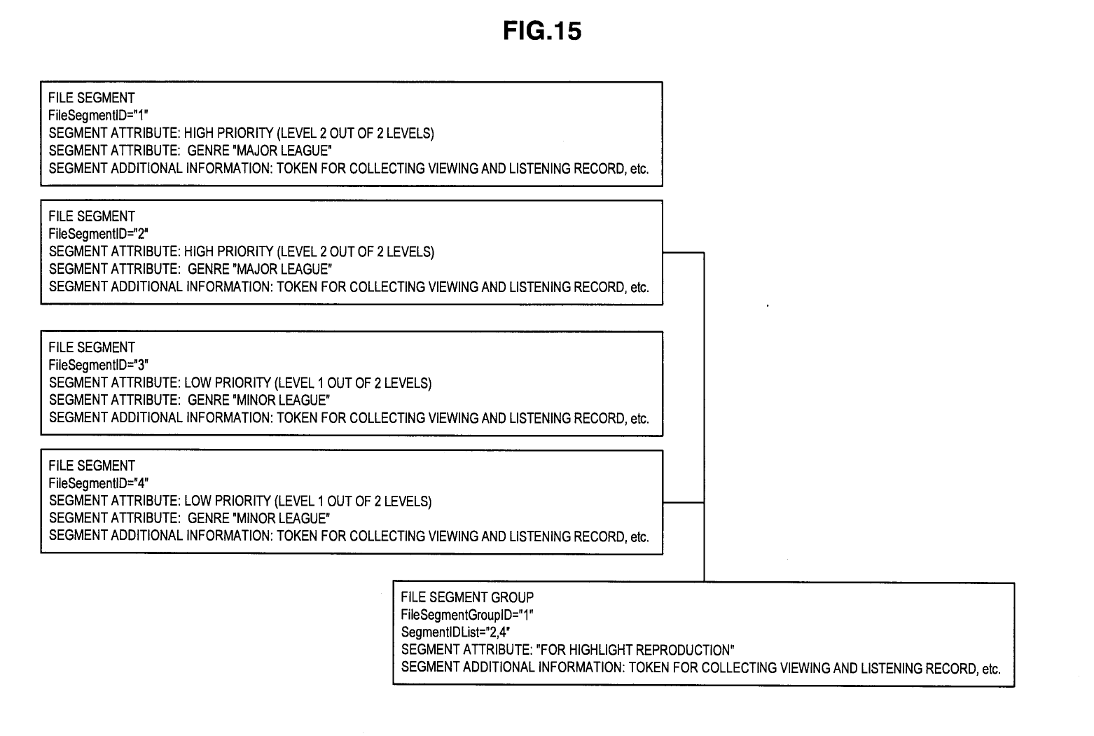

FIG. 14 is an explanatory diagram showing a description example of the file segment metafile. FIG. 15 is an explanatory diagram schematically showing the contents of the file segment metafile. The character strings in italics shown in FIG. 14 indicate the meaning of the description immediately above each character string. For example, the descriptions in line 2, <FileSegment id=“1”>, and line 3, <Attribute urn=“urn:capturingPriority[higherTherBetter, max2]:2”/>, mean that a file segment whose ID is 1 has the highest priority where the maximum level is two.

The file segment metafile shown in FIG. 14 defines file segments whose IDs are 1 to 4 and a file segment group as shown in FIG. 15. Further, it is indicated that the file segment whose ID is 3 has a low priority and the genre thereof is “minor league”, for example.

Here, returning to the explanation of the configuration of the node 20 with reference to FIG. 8, the scheme establishment section 234 establishes an acquisition scheme for acquiring a file segment based on the file segment metafile acquired by the file segment metafile acquisition section 233.

For example, the scheme establishment section 234 establishes an acquisition scheme fro acquiring file segments sequentially from the file segment with the highest priority, for acquiring only the file segments with high priority, or for acquiring only the file segments for a specific genre. The scheme establishment section 234 can also establish an acquisition scheme for acquiring a file segment group whose segment attribute is for reproduction of highlights. Incidentally, based on what criterion the scheme establishment section 234 establishes an acquisition scheme for acquiring a file segment may be set by users.

The file acquisition section 236 has a function of a divided data acquisition section for acquiring a file segment or a file segment group according to the acquisition scheme established by the scheme establishment section 234. A procedure of the file acquisition section 236 acquiring a file segment will be explained in the following.

When acquiring a file segment, the file acquisition section 236 first calculates the hash value of the name of the file segment. Then, the file acquisition section 236 asks the node address resolution server 14 for the network address of a node having a node ID whose management range includes the calculated hash value of the file segment and acquires the network address.

Note that, in this specification, it is assumed that a file segment name is “targetFile” with a file segment ID added thereto. For example, it is assumed that the file segment name of a file segment whose file segment ID is 1 is “targetFile-1”. Further, such a file segment name functions as divided data specifying information indicating the file segment.

Then, by transmitting a file segment name as a name resolution request to a node having the network address acquired from the node address resolution server 14, the file acquisition section 236 acquires the URL of the file segment from the URL extraction section 222 of the node. Then, the file acquisition section 236 acquires the entity of the file segment from the location indicated by the acquired URL of the file segment.

Incidentally, there is a case where the file acquisition section 236 acquires, for a file segment, multiple URLs of the file segment. In this case, the file acquisition section 236 may select one URL from the multiple URLs of the file segment and acquire the entity of the file segment from the location indicated by the selected URL. With such a configuration, with the file acquisition section 236 acquiring the entity of the file segment selectively from a node from which the file segment may be easily acquired depending on, for example, the network congestion or the like, the efficiency in acquiring the file segment may be improved.

Further, a node storing multiple URLs of a file segment in the name resolution table storage section 224 may, upon a name resolution request from the other node, select one URL of the file segment from the multiple URLs of the file segment and transmit the same to the other node.

The file acquisition section 236, following such a procedure, sequentially acquires file segments according to the acquisition order of the file segments established by the scheme establishment section 234. The acquisition order of the file segments established by the scheme establishment section 234 may be the order of file segments desired by users for viewing and listening. In this case, the rendering processing section 260 can sequentially reproduce the file segments in the order desired by users for viewing and listening in parallel with the acquisition of the file segments by the file acquisition section 236.

The reproduction instruction section 238 instructs the rendering processing section 260 to reproduce the file segment acquired by the file acquisition section 236. That is, the rendering processing section 260 has a function of a reproduction section making an output device for video and audio reproduce content in response to an instruction from the reproduction instruction section 238.

The file server processing section 240 includes a recording section 242, a file storage section 244, a URL notification section 246, a chunk processing section 248, a file segment metafile generation section 249, an RSS generation section 250 and a file transfer section 252.

The recording section 242 records in the file storage section 244 the file segment of content acquired by the file acquisition section 236. The file storage section 244 stores the file segment of the content, content data that is not chunked and the like. A node including such file storage section 244 functions as a content storage apparatus. Note that, in FIG. 8, the name resolution table storage section 224 and the file storage section 244 are shown as separate components. However, in the actual case, the name resolution table storage section 224 and the file storage section 244 may be physically one storage medium.

Further, the name resolution table storage section 224 and the file storage section 244 may be a storage medium such as, for example, a non-volatile memory such as an EEPROM (Electrically Erasable Programmable Read-Only Memory), an EPROM (Erasable Programmable Read Only Memory) or the like, a magnetic disk such as a hard disk, a circular magnetic disk or the like, an optical disk such as a CD-R (Compact Disc Recordable)/RW (Rewritable), a DVD-R (Digital Versatile Disc Recordable)/RW/+R/+RW/RAM (Random Access Memory), a BD (Blu-ray Disc (registered trademark))-R/BD-RE or the like, or a MO (Magneto Optical) disk.

The URL notification section 246 functions as a transmission section for transmitting a URL indicating the location in the file storage section 244 of a file segment newly stored in the file storage section 244 by the recording section 242 to a node whose management range includes the hash value of the name of the file segment. The table management section 226 of the node that received a URL of a file segment from the URL notification section 246 can add in the name resolution table storage section 224 the URL of the file segment received from the URL notification section 246 as the URL of the file segment. As a result, it becomes possible for multiple nodes desiring to acquire the file segment later on to acquire the file segment from different nodes in a distributed manner.

Further, the URL notification section 246 transmits to each of the corresponding node a URL indicating the location of each file segment in the file storage section 244 acquired by the chunk processing section 248 described later chunking content. The table management section 226 of a node that received the URL of a file segment from the URL notification section 246 can store in the name resolution table storage section 224 the URL of the file segment received from the URL notification section 246 as the URL of the file segment.

The chunk processing section 248 functions as a dividing section for chunking (dividing) arbitrary content data and acquiring multiple file segments (divided data). Each of the file segments acquired by the chunking by the chunk processing section 248 may be stored in the file storage section 244 by the recording section 242. In this case, the URL notification section 246 may transmit the URL indicating the location of each file segment in the file storage section 244 to each of the corresponding nodes along with the hash value of the file segment name.

The file segment metafile generation section 249 generates a file segment metafile in which an attribute or a token of each file segment chunked by the chunk processing section 248 or of a file segment group is described. The file segment metafile has been described above with reference to FIGS. 12 to 15.

Incidentally, the attribute of each file segment or of a file segment group may be extracted by automatically processing each file segment or it may be input by users. The file segment metafile generated by the file segment metafile generation section 249 is stored in the file storage section 244, for example.

When a file segment metafile of certain content is generated by the file segment metafile generation section 249, the RSS generation section 250 generates an RSS feed of the content. Specifically, the RSS generation section 250 generates an RSS feed including an <enclosure> element in which the URL of the file segment metafile of the content is described. The RSS feed generated by the RSS generation section 250 is multicast to other nodes via the RSS multicast server 16.

When the file transfer section 252 is requested by the file acquisition section 236 of the other node to transfer the file segment stored in the file storage section 244, the file transfer section 252 transfers the file segment to the other node.

Incidentally, heretofore, contents to be described in the <enclosure> element of the RSS feed in case the content data is chunked has been explained. However, when the content data is not chunked, the <enclosure> element of the RSS feed may have a content name described therein. In this case, the file acquisition section 236 specifies, based on a hash value of the content name described in the <enclosure> element, a node to which a request is to be made for the name resolution for the content and acquires the entity of the content from the location indicated by the URL acquired from the node.

### (3-3) Operation of the Content Acquisition System

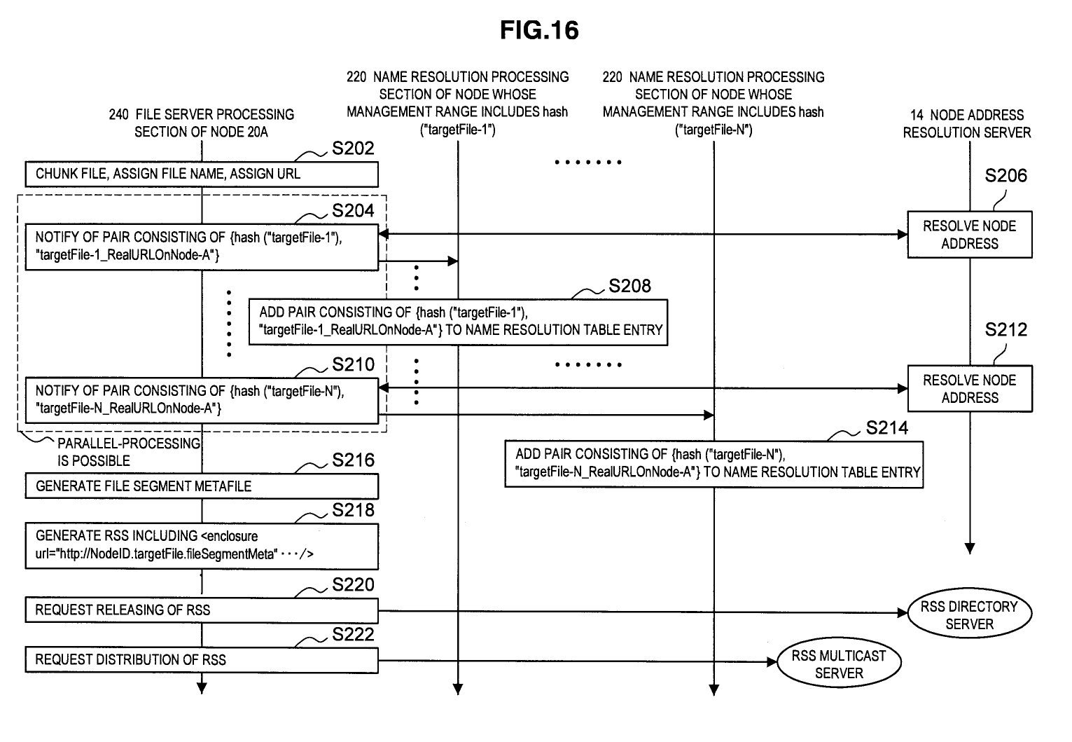

Heretofore, the functions of the node 20 according to the present embodiment have been explained with reference to FIGS. 8 to 15. Subsequently, with reference to FIGS. 16 to 22, the operation of the content acquisition system according to the present embodiment will be explained.

FIG. 16 is a sequence diagram showing a flow from chunking of content to releasing of an RSS feed. First, the chunk processing section 248 of the file server processing section 240 of the node 20A chunks the file of content, assigns a file name to each file segment, and assigns an URL in the file storage section 244 to each file segment (S202). For example, when the file name of the content is “targetFile”, the chunk processing section 248 assigns a name “targetFile.FileSegmentID” to each file segment. Note that the file segment ID (FileSegmentID) is an identifier unique to each node 20. Further, “NodeID” may be added to the file segment name.

Subsequently, the URL notification section 246 of the file server processing section 240 of the node 20A notifies a node whose management range includes the hash value of “targetFile-1” of a pair consisting of the hash value of “targetFile-1” and the URL of “targetFile-1” (S204). At that time, the URL notification section 246 acquires from the node address resolution server 14 the network address of the node whose management range includes the hash value of “targetFile-1” (S206). Subsequently, the name resolution processing section 220 of the node whose management range includes the hash value of “targetFile-1” stores the pair consisting of the hash value of “targetFile-1” and the URL of “targetFile-1” in the name resolution table storage section 224 as a name resolution table entry (S208).

Further, the URL notification section 246 of the file server processing section 240 of the node 20A performs the same processing for the file segments “targetFile-2” to “targetFile-N”. For example, the URL notification section 246 notifies a node whose management range includes the hash value of “targetFile-N” of a pair consisting of the hash value of “targetFile-N” and the URL of “targetFile-N” (S210). At that time, the URL notification section 246 acquires from the node address resolution server 14 the network address of the node whose management range includes the hash value of “targetFile-N” (S212). Subsequently, the name resolution processing section 220 of the node whose management range includes the hash value of “targetFile-N” stores the pair consisting of the hash value of “targetFile-N” and the URL of “targetFile-N” in the name resolution table storage section 224 as a name resolution table entry (S214). Incidentally, N indicates the number of the file segments acquired by chunking the file of the content.

Then, the file segment metafile generation section 249 of the file server processing section 240 of the node 20A generates a file segment metafile whose name is “NodeID.targetFile.fileSegmentMeta” (S216). Subsequently, the RSS generation section 250 of the file server processing section 240 of the node 20A generates an RSS feed for which “http://NodeID.targetFile.fileSegmentMeta”, for example, is described in the <enclosure> element (S218).

Then, the RSS generation section 250 of the file server processing section 240 of the node 20A releases the generated RSS feed via the RSS directory server and the RSS multicast server 16 (S220, S222). As such, by using the RSS directory server and the RSS multicast server 16 in combination, the efficiency of the RSS feed distribution may be improved.

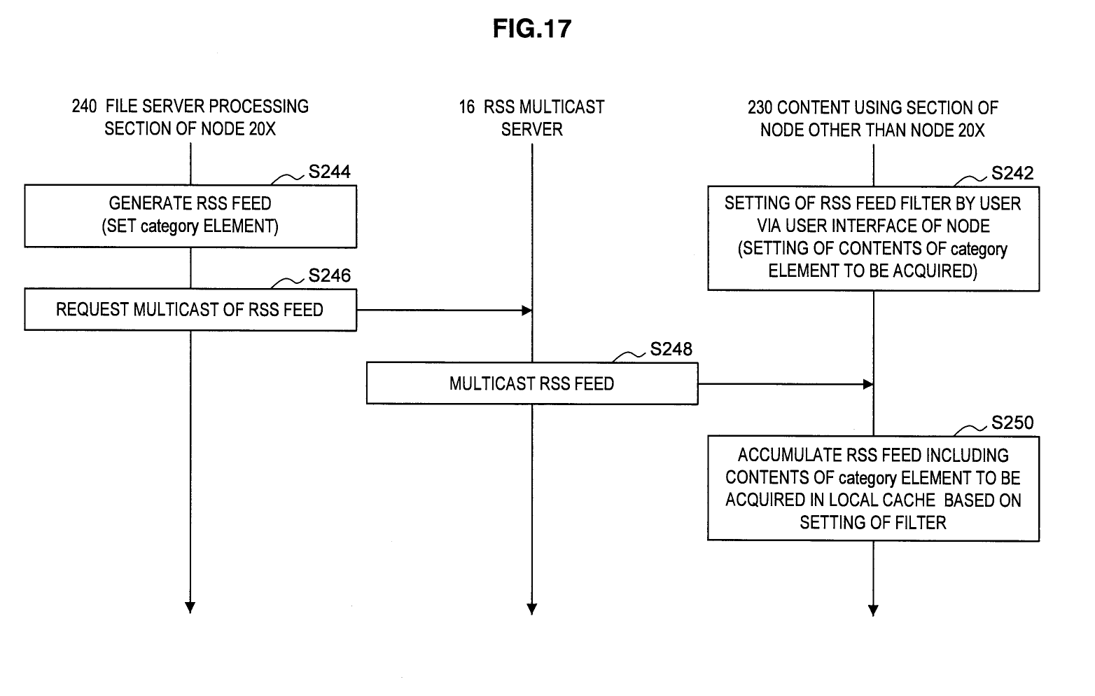

FIG. 17 is a sequence diagram showing a flow of the RSS multicast server 16 multicasting the RSS feed. As shown in FIG. 17, in the content using section 230 of the node 20 other than the node 20A, a filter for the RSS feed is set by users via a user interface (S242). Specifically, specific contents of a <category> element are set.

On the other hand, when the file server processing section 240 of the node 20A generates an RSS feed in which a <category> element is described (S244), the file server processing section 240 requests the RSS multicast server 16 to multicast the RSS feed (S246).

The RSS multicast server 16 that is requested to multicast the RSS feed multicasts the RSS feed to the content using section 230 of the node 20 subscribing to an RSS feed multicast service (S248).

The file acquisition section 236 of the content using section 230 of the node 20 that received the RSS feed accumulates the received RSS feed in the RSS feed local cache of the node 20 that includes the file acquisition section 236 (S250). The file acquisition section 236 of the node 20 periodically deletes the RSS feeds accumulated in the RSS feed local cache from the oldest.

Incidentally, with regard to the accumulation of the RSS feeds as shown in S250, the file acquisition section 236 of the node 20 filters the RSS feed received based on the contents of the <category> element of the RSS feed. For example, as the element for identifying the category of an RSS feed of RSS (RSS2.0), there is a category element of a channel element that can be stored in the RSS element, and a category to which a channel belongs can be specified. For example, a category indicating baseball broadcast is expressed as <category>baseball broadcast</category>.

Also, by using a domain attribute of the <category> element, it becomes possible to specify a domain and to specify a classification item defined therein. <category domain=“http://www.a.com/category”>sports/baseball/major League</category>

When filtering the RSS feed with such a category attribute in text in the RSS feed, a load is possibly put on the processing system. Thus, a method for improving the filtering efficiency by defining a filter attribute in binary form and filtering with the binary index is described in, for example, JP-A-2001-216184.

In case of using the above method, as the domain attribute of the <category> element, the binary index for which a domain such as “http://www.a.com/binaryCategoryIndex” is specified and which is base64 encoded, such as “8tu3hf75yt6ei”, is described. <category domain=“http://www.a.com/binaryCategoryIndex”>8tu3hf75yt6ei</category>

When receiving such an RSS feed, the node 20 decodes the base64 encoded binary index and uses the binary index for filtering.

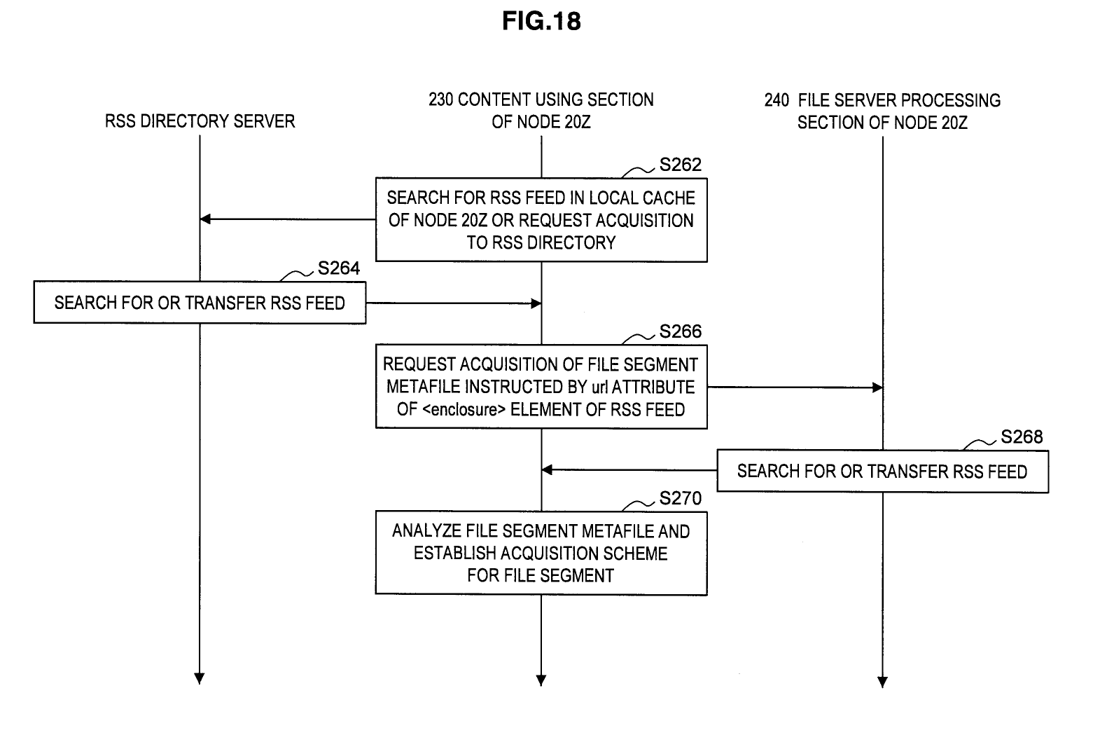

FIG. 18 is a sequence diagram showing a flow of acquiring the file segment metafile. First, the content using section 230 of the node 20Z searches for or acquires the RSS feed of content to be acquired (S262). Specifically, the content using section 230 of the node 20Z searches for the RSS feed of the content to be acquired based on the metadata described in the RSS feed that is multicast from the RSS multicast server 16 and accumulated in the RSS feed local cache (RSS acquisition section 232). Or, the content using section 230 of the node 20Z requests the RSS directory server for the RSS feed, and the RSS directory server searches for the requested RSS feed and transmits the RSS feed to the node 20Z (S264).

Then, the file segment metafile acquisition section 233 of the content using section 230 of the node 20Z requests the file server processing section 240 of the node 20A indicated by the url of the <enclosure> element included in the RSS feed of the content to be acquired for the file segment metafile (S266). The file server processing section 240 of the node 20A searches for the requested file segment metafile and transmits the file segment metafile to the node 20Z (S268).

Subsequently, the scheme establishment section 234 of the content using section 230 of the node 20Z analyzes the contents of the file segment metafile received from the node 20A and establishes an acquisition scheme for acquiring the file segments based on a certain criterion (S270). As an example of the certain criterion, there is a criterion of acquiring the file segments sequentially from the highest priority file segment, of acquiring first the highlight file segment group, or the like. Further, a criterion different from these may be used as the certain criterion.

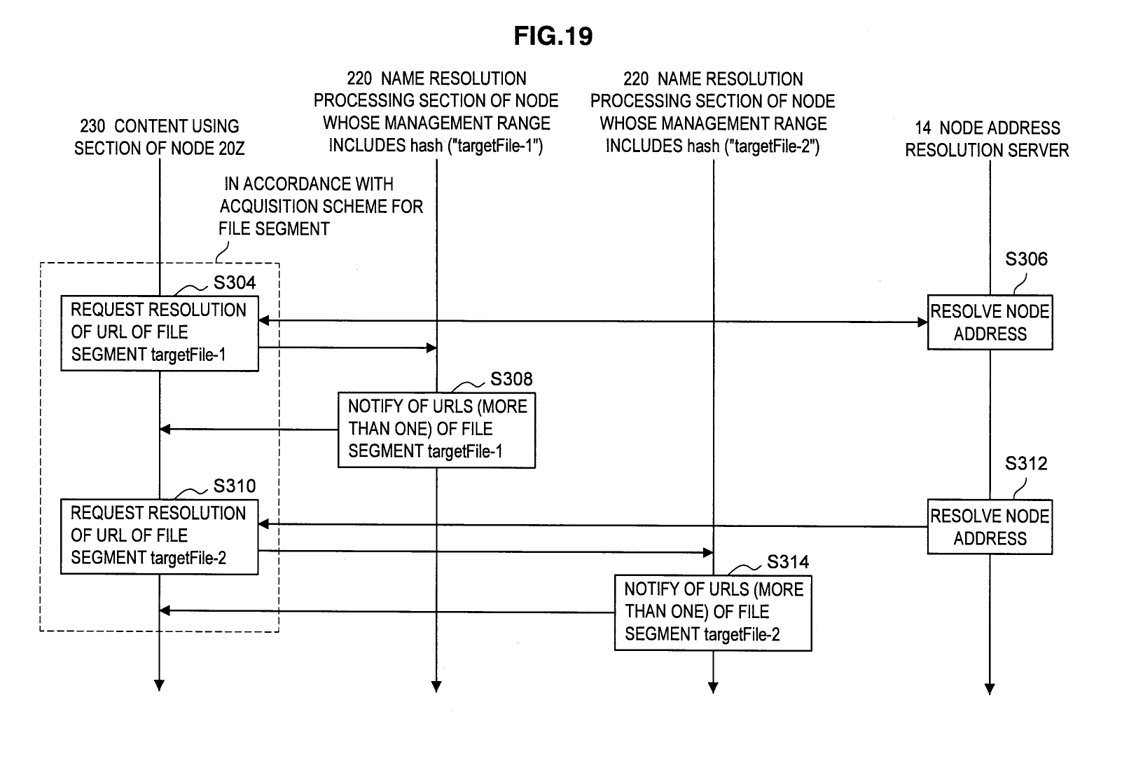

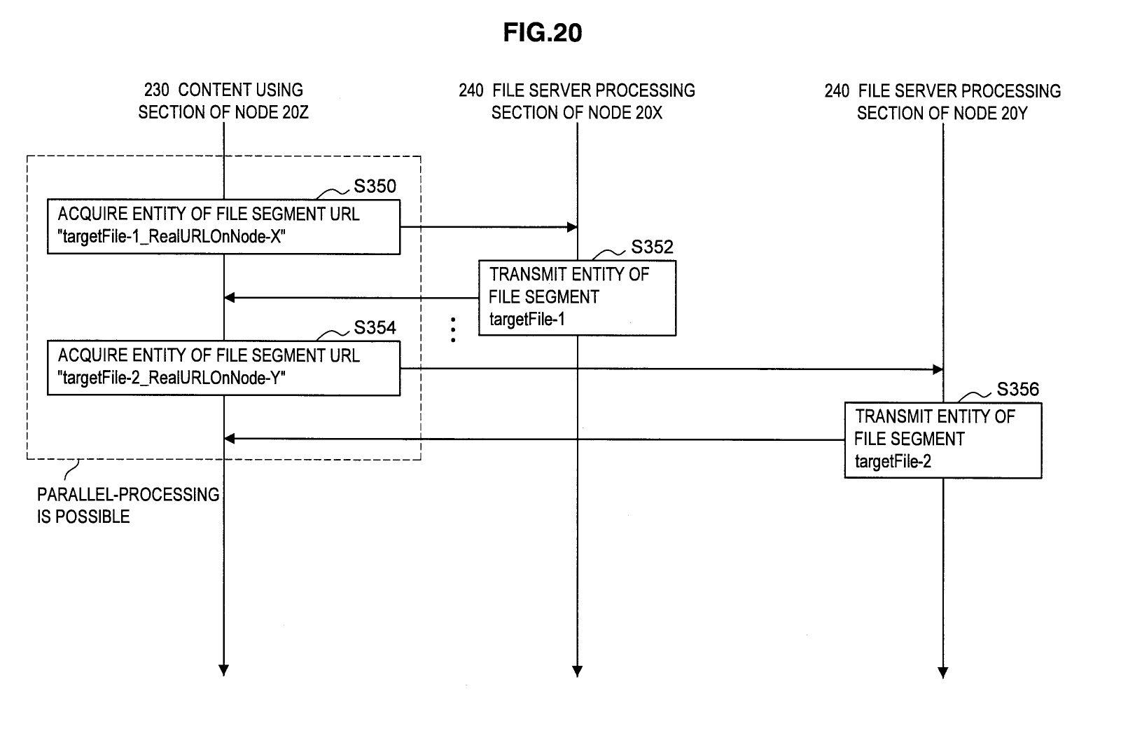

FIGS. 19 to 22 are sequence diagrams showing a flow from acquisition of a file segment to reproduction of content. Note that, FIGS. 19 to 20 show the processings following the processing shown in FIG. 18. It is assumed that, in S270 of FIG. 18, the scheme establishment section 234 of the content using section 230 of the node 20Z established the acquisition scheme for acquiring “targetFile-1” and “targetFile-2”, which are the file segments of “targetFile”.

In this case, as shown in FIG. 19, the file acquisition section 236 of the content using section 230 of the node 20Z asks the name resolution processing section 220 of a node whose management range includes the hash value of “targetFile-1” for the URL of “targetFile-1” (S304). At that time, the file acquisition section 236 acquires from the node address resolution server 14 the network address of the node whose management range includes the hash value of “targetFile-1” (S306). Then, the node whose management range includes the hash value of “targetFile-1” transmits the URL of “targetFile-1” to the node 20Z (S308).

Subsequently, the file acquisition section 236 of the node 20Z asks the name resolution processing section 220 of a node whose management range includes the hash value of “targetFile-2” for the URL of “targetFile-2” (S310). At this time, the file acquisition section 236 acquires from the node address resolution server 14 the network address of the node whose management range includes the hash value of “targetFile-2” (S312). Then, the node whose management range includes the hash value of “targetFile-2” transmits the URL of “targetFile-2” to the node 20Z (S314).

Then, as shown in FIG. 20, the file acquisition section 236 of the content using section 230 of the node 20Z requests the file server processing section 240 of the node 20X for the transmission of “targetFile-1” based on the acquired URL of “targetFile-1” (S350). In response to the request from the node 20Z, the file server processing section 240 of the node 20X transmits “targetFile-1” to the node 20Z (S352).

Similarly, the file acquisition section 236 requests the file server processing section 240 of the node 20Y for the transmission of “targetFile-2” based on the acquired URL of “targetFile-2” (S354). In response to the request from the node 20Z, the file server processing section 240 of the node 20Y transmits “targetFile-2” to the node 20Z (S356).

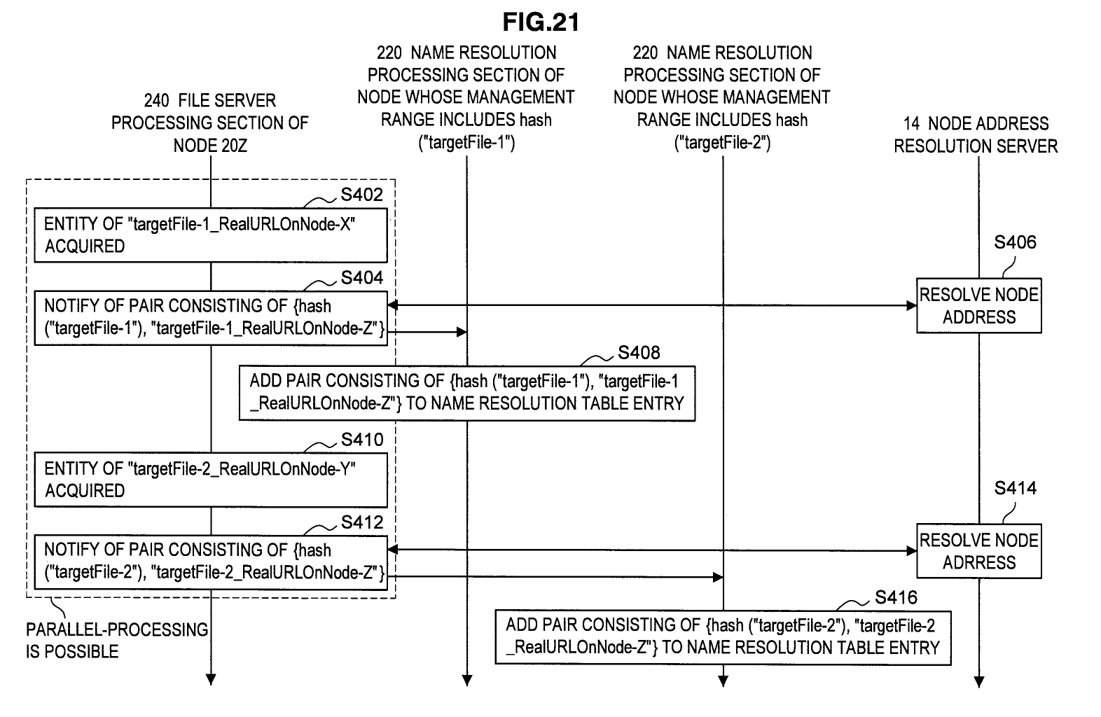

Subsequently, as shown in FIG. 21, when “targetFile-1” acquired by the file acquisition section 236 of the content using section 230 of the node 20Z is stored in the file storage section 244 (S402), the URL notification section 246 notifies the node whose management range includes the hash value of “targetFile-1” of a pair consisting of the hash value of “targetFile-1” and the URL indicating the location of “targetFile-1” in the file storage section 244 (S404). At that time, the URL notification section 246 acquires from the node address resolution server 14 the network address of the node whose management range includes the hash value of “targetFile-1” (S406). The name resolution processing section 220 of the node whose management range includes the hash value of “targetFile-1” adds the pair consisting of the hash value of “targetFile-1” and the URL indicating the location of “targetFile-1” in the file storage section 244 as a name resolution table entry (S408).

Then, when “targetFile-2” acquired by the file acquisition section 236 is stored in the file storage section 244 (S410), the URL notification section 246 notifies a node whose management range includes the hash value of “targetFile-2” of a pair consisting of the hash value of “targetFile-2” and the URL indicating the location of “targetFile-2” in the file storage section 244 (S412). At that time, the URL notification section 246 acquires from the node address resolution server 14 the network address of the node whose management range includes the hash value of “targetFile-2” (S414). The name resolution processing section 220 of the node whose management range includes the hash value of “targetFile-2” adds the pair consisting of the hash value of “targetFile-2” and the URL indicating the location of “targetFile-2” in the file storage section 244 as a name resolution table entry (S416).

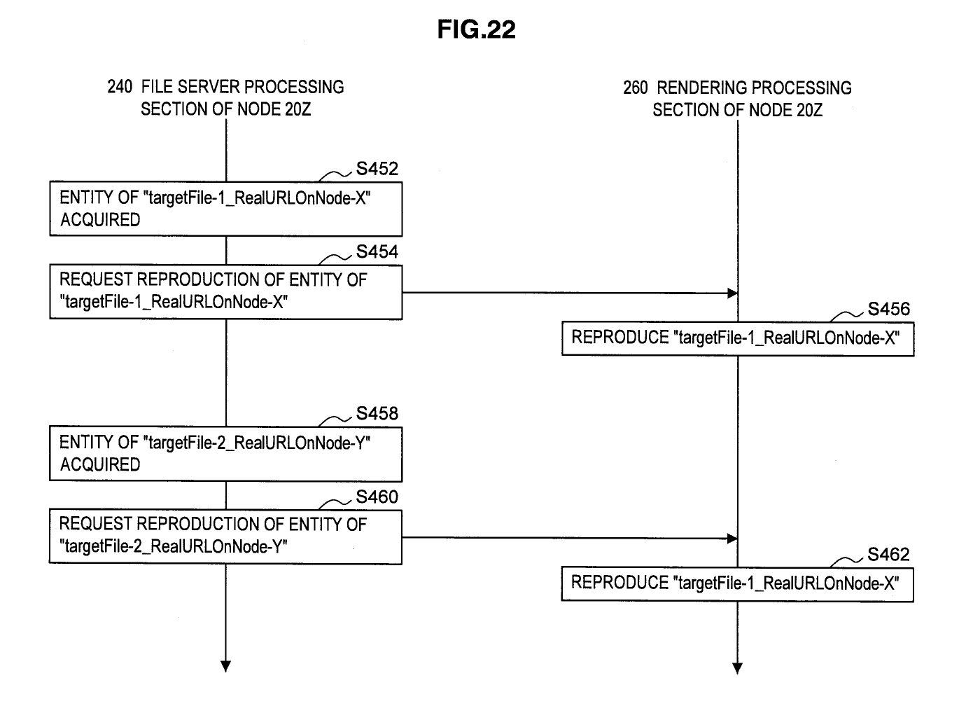

On the other hand, in parallel with the processing shown in FIG. 21, the rendering processing section 260 of the node 20Z sequentially reproduces contents, in consideration of the order of file segments, starting with a file segment acquired. Specifically, as shown in FIG. 22, when “targetFile-1” acquired by the file acquisition section 236 of the node 20Z is stored in the file storage section 244 (S452), the file server processing section 240 requests the rendering processing section 260 to reproduce “targetFile-1” (S454). In response to the request from the file server processing section 240, the rendering processing section 260 starts the reproduction of “targetFile-1” (S456).

Then, with the node 20Z, when “targetFile-2” acquired by the file acquisition section 236 is stored in the file storage section 244 (S458), the file server processing section 240 requests the rendering processing section 260 to reproduce “targetFile-2” (S460). In response to the request from the file server processing section 240, the rendering processing section 260 starts the reproduction of “targetFile-2” (S462).

### (4) Conclusion

As explained above, according to the present embodiment, a file segment metafile including the attribute information of multiple file segments acquired by chunking content is acquired by the file segment metafile acquisition section 233. Accordingly, the scheme establishment section 234 can establish an acquisition scheme for acquiring the multiple file segments based on the file segment metafile acquired by the file segment metafile acquisition section 233. Also, since the file acquisition section 236 acquires the file segment according to the acquisition scheme, it becomes possible for the node 20 according to the present embodiment to acquire only a part of the multiple file segments or to acquire the file segments in a specific order, for example.

Heretofore, the preferred embodiments of the present invention have been explained with reference to the appended drawings. However, it is needles to say that the present invention is not limited to such examples. It is obvious that various modifications and alterations may be achieved by those skilled in the art within the scope of the claims, and it is understood that they are naturally within the scope of the claims.

For example, it is not necessary to perform the steps of the processing by the content acquisition system 1 in this specification in a time sequence following the order described in the sequence diagrams. For example, each step of the processing by the content acquisition system 1 may include a processing that is performed in parallel or individually (for example, parallel processing or object-based processing).

Further, it is possible to create a computer program that makes hardware embedded in the node 20, such as the CPU 201, the ROM 202 and the RAM 203, fulfill the function equivalent to that of each component of the node 20 described above. Further, a storage medium is provided in which the computer program is stored. Further, by configuring each of the function blocks shown in the function block diagram of FIG. 8 with hardware, it is possible to realize the series of processing with hardware.

What is claimed is:

1. A content acquisition apparatus comprising:
a receiving section for receiving an RSS feed including first location information indicating a location of metadata of multiple divided data acquired by dividing content data;
a metadata acquisition section for acquiring the metadata from the location indicated in the first location information included in the RSS feed;
a scheme establishment section for establishing an acquisition scheme for acquiring the multiple divided data based on an attribute of each divided data or an attribute of a divided data group including two or more divided data indicated by the metadata; and
a divided data acquisition section for acquiring a part or all of the multiple divided data according to the acquisition scheme established by the scheme establishment section.

2. The content acquisition apparatus according to claim 1, wherein
the metadata includes divided data specifying information indicating each of the multiple divided data;
a location information storage apparatus specified based on the divided data specifying information stores second location information indicating a location of the divided data; and
the divided data acquisition section acquires the second location information of the divided data from the location information storage apparatus specified based on the divided data specifying information and acquires the divided data from a content storage apparatus indicated by the second location information.

3. The content acquisition apparatus according to claim 1, wherein
the RSS feed received by the receiving section further includes category information indicating a category of the RSS feed; and
the metadata acquisition section acquires the metadata from the location indicated by the first location information included in the RSS feed including specific category information.

4. The content acquisition apparatus according to claim 1, wherein
the metadata includes information indicating a priority rank of the divided data.

5. The content acquisition apparatus according to claim 1, wherein
the metadata includes a summary of the divided data.

6. A program for causing a computer to function as:
a receiving section for receiving an RSS feed including first location information indicating a location of metadata of multiple divided data acquired by dividing content data;
a metadata acquisition section for acquiring the metadata from the location indicated in the first location information included in the RSS feed;
a scheme establishment section for establishing an acquisition scheme for acquiring the multiple divided data based on an attribute of each divided data or an attribute of divided data group including two or more divided data indicated by the metadata; and
a divided data acquisition section acquiring a part or all of the multiple divided data according to the acquisition scheme established by the scheme establishment section.

7. A content acquisition method to be executed in a content acquisition apparatus, comprising the steps of:
receiving an RSS feed including first location information indicating a location of metadata of multiple divided data acquired by dividing content data;
acquiring the metadata from the location indicated in the first location information included in the RSS feed;
establishing an acquisition scheme for acquiring the multiple divided data based on an attribute of each divided data or an attribute of a divided data group including two or more divided data indicated by the metadata; and
acquiring a part or all of the multiple divided data according to the established acquisition scheme.

8. A content acquisition system comprising an RSS generation apparatus for generating an RSS feed and a content acquisition apparatus for acquiring the RSS feed generated by the RSS generation apparatus, wherein
the RSS generation apparatus generates the RSS feed including first location information indicating a location of metadata of multiple divided data acquired by dividing content data, and
the content acquisition apparatus includes:
a receiving section for receiving the RSS feed generated by the RSS generation apparatus;
a metadata acquisition section for acquiring the metadata from the location indicated in the first location information included in the RSS feed;
a scheme establishment section for establishing an acquisition scheme for acquiring the multiple divided data based on an attribute of each divided data or an attribute of a divided data group including two or more divided data indicated by the metadata; and
a divided data acquisition section for acquiring a part or all of the multiple divided data according to the acquisition scheme established by the scheme establishment section.
